(19) United States
(12) Patent Application Publication
(10) Pub. No.: US 2025/0382843 A1
(43) Pub. Date: Dec. 18, 2025

(54) ADJUSTABLE WINDOW SHADE, MODULAR WINDOW SHADE APPARATUS, AND DEVICES AND METHODS FOR REGULATING SAME

(71) Applicant: Jacob Fleischman, Brooklyn, NY (US)

(72) Inventor: Jacob Fleischman, Brooklyn, NY (US)

(21) Appl. No.: 19/060,616

(22) Filed: Feb. 21, 2025

Related U.S. Application Data
(60) Provisional application No. 63/555,953, filed on Feb. 21, 2024.

(51) Int. Cl. E06B 9/44; E06B 9/68; E06B 9/78

(52) U.S. Cl. CPC E06B 9/44; E06B 9/78; E06B 2009/6809; E06B 2009/785

(57) ABSTRACT

A window shade apparatus may include a cassette (12), a major tube (36), a minor tube (38), and a bottom bar (14). The bottom bar may include a cover track (432), a tubular rod (434), a bearing insert (436) arranged in the tubular rod, and an end cap (438) connected to the cover track. The end cap may include a circular cylindrical shaft (480) that is telescopically received in the bearing insert. A sheet of flexible material (16) that traverses the tubular rod and forms a proximal sheet between the major tube and the tubular rod and a distal sheet between the minor tube and the tubular rod. A differential adjustment device (46) is disclosed for adjusting the shade. An adjustable stop device (44) is disclosed that regulates the maximum deployment length of flexible material from the major tube.

### CROSS REFERENCE TO RELATED APPLICATIONS

This application claims the benefit of U.S. Patent Application No. 63/555,953 filed Feb. 21, 2014. The entire disclosure of U.S. Patent Application No. 63/555,953 is incorporated by reference herein.

### FIELD OF THE INVENTION

The present invention generally relates to an adjustable window shade. More particularly, this invention relates to an apparatus for regulating alignment of light transmitting regions and light blocking regions of a zebra shade. Additionally, the invention relates to an adjustable stop for regulating operation of a window shade. Moreover, the invention relates to a bottom bar for a zebra shade and an adjustable bracket for a window shade tube. Further, the invention relates to a cassette and modular components for configuring a window shade in a normal roll configuration or a reverse roll configuration. Also, the invention relates to a tool and methods for covering a cassette or bottom bar in a flexible material.

### BACKGROUND

Window shades may require adjustment after installation or during operation to provide enhanced esthetic appeal or performance. Accordingly, a need exists for new window shades which may be adjusted during installation or during use to enhance esthetic appeal, operational performance, or economy.

### SUMMARY

The present disclosure is generally directed toward adjustable window shades, a modular window shade apparatus, and devices and methods for regulating operation of a window shade. More particularly, the present disclosure presents an exemplary embodiment of an adjustable window shade. Also, the present disclosure is directed toward modular window shade devices, as well as methods for regulating operation of a window shade. More specifically, a window shade apparatus is disclosed. The window shade apparatus may include a cassette for housing a window shade, a major tube for spooling a sheet of flexible material for a shade, a minor tube disposed adjacent to the major tube, and a bottom bar. The bottom bar may include a cover track, a tubular rod, a bearing insert arranged in the tubular rod, and an end cap connected to the cover track. The end cap may an end wall, and a circular cylindrical shaft projecting from the end wall, the circular cylindrical shaft may be telescopically received in the bearing insert. Additionally, the window shade apparatus may include a sheet of flexible material which includes a first edge secured to the major tube and a second edge secured to the minor tube. The sheet of flexible material may traverse the tubular rod and form a proximal sheet of flexible material extending between the major tube and the tubular rod and a distal sheet of flexible material extending between the minor tube and the tubular rod to form a shade. Additionally, a differential adjustment device may be connected to the minor tube for selectively rotating the minor tube. The differential device may include a first worm drive for rotating the minor tube. The window shade apparatus may further include an idler-adjustable stop device disposed in the major tube that includes a second worm drive which selectively regulates the maximum deployment length of the sheet of flexible material that can be unspooled from the major tube.

### DESCRIPTION OF THE DRAWINGS

In the accompanying drawings, which form part of this specification and are to be read in conjunction therewith and in which like reference numerals are used to indicate like parts in the various views:

FIG. 1 is a perspective view of an illustrative window shade the window shade being in a lowered position and arranged in a first configuration;

FIG. 2 is a perspective view of the window shade of FIG. 1, the window shade being in a lowered position and arranged in a second configuration;

FIG. 3 is a perspective view of the window shade of FIG. 1, the window shade being in a lowered position and arranged in a third configuration;

FIG. 4 is an exploded view of the window shade of FIG. 1;

FIG. 5 is a port side view of the window shade of FIG. 1 installed in a window frame, the window shade and the window frame being arranged in a normal roll configuration;

FIG. 6 is a perspective view of the cassette of FIG. 1;

FIG. 7 is a port side view of the cassette of FIG. 6;

FIG. 8 is a perspective view of the differential adjustment device of FIG. 1;

FIG. 9 is another perspective view of the differential adjustment device of FIG. 1;

FIG. 10 is a partial sectional view of the worm drive of FIG. 8;

FIG. 11 is an exploded view of the worm drive of FIG. 8 in a first operable arrangement;

FIG. 12 is an exploded view of the worm drive of FIG. 8 in a second operable arrangement;

FIG. 13 is an exploded view of the differential adjustment device and minor tube assembly;

FIG. 14 is a side view of the worm screw of FIG. 8;

FIG. 15 is a sectional view of FIG. 14, along line 15-15;

FIG. 16 is a top view of the worm screw of FIG. 8;

FIG. 17 is a bottom view of the worm screw of FIG. 8;

FIG. 18 is a side view of the worm screw of FIG. 8;

FIG. 19 is a front view of the worm screw of FIG. 8;

FIG. 20 is a perspective view of the port side casing of the worm drive of FIG. 8;

FIG. 21 is a starboard side view of the port side casing of FIG. 20;

FIG. 22 is a sectional view of the port side casing of FIG. 21, along line 22-22;

FIG. 23 is a perspective view of the starboard side casing of the worm drive of FIG. 8;

FIG. 24 is a port side view of the starboard side casing of FIG. 23;

FIG. 25 is a sectional view of the starboard side casing of FIG. 24, along line 25-25;

FIG. 26 is a partial sectional view of the window shade of FIG. 5, along line 26-26;

FIG. 27 is a sectional view of the idler-adjustable stop (IAS) device and tube assembly of FIG. 26, along line 27-27;

FIG. 28 is a sectional view of the IAS device and tube assembly of FIG. 26, along line 28-28;

FIG. 29 is a sectional view of the IAS device and tube assembly of FIG. 26, along line 29-29;

FIG. 30 is a sectional view of the IAS device and tube assembly of FIG. 26, along line 30-30;

FIG. 31 is a sectional view of the IAS device and tube assembly of FIG. 26, along line 31-31;

FIG. 32 is a sectional view of the IAS device and tube assembly of FIG. 26, along line 32-32;

FIG. 33 is a sectional view of the IAS device and tube assembly of FIG. 26, along line 33-33;

FIG. 34 is a sectional view of the IAS device and tube assembly of FIG. 26, along line 34-34;

FIG. 35 is a sectional view of the IAS device and tube assembly of FIG. 26, along line 35-35;

FIG. 36 is a sectional view of the IAS device and tube assembly of FIG. 26, along line 36-36;

FIG. 37 is a sectional view of the IAS device and tube assembly of FIG. 36, along line 37-37;

FIG. 38 is a perspective view of the IAS device of FIG. 4;

FIG. 39 is another perspective view of the IAS device of FIG. 4;

FIG. 40 is an exploded view of the IAS device and tube assembly of FIG. 39

FIG. 41 is another exploded view of the IAS device and tube assembly of FIG. 39

FIG. 42 is partial sectional view of the IAS device and tube assembly of FIG. 26, the IAS device and tube assembly being in an intermediate (or ready) configuration;

FIG. 43 is partial sectional view of the IAS device and tube assembly of FIG. 26, the IAS device and tube assembly being in a first (or proximal) stop configuration;

FIG. 44 is partial sectional view of the IAS device and tube assembly of FIG. 26, the IAS device and tube assembly being in a second (or distal) stop configuration;

FIG. 45 is an exploded view of the adjustable stop worm drive housing of FIG. 40;

FIG. 46 is a front view of the adjustable stop worm drive housing of FIG. 40

FIG. 47 is a sectional view of the adjustable stop worm drive housing of FIG. 46, along line 47-47;

FIG. 48 is a sectional view of the adjustable stop worm drive housing of FIG. 46, along line 48-48;

FIG. 49 is a plan view of the worm screw of FIG. 45;

FIG. 50 is a sectional view of the worm screw of FIG. 49, along 50-50;

FIG. 51 is a top view of the worm screw of FIG. 49;

FIG. 52 is a bottom view of the worm screw of FIG. 49;

FIG. 53 is a perspective view of the worm gear of FIG. 45;

FIG. 54 is a front view of the worm gear of FIG. 45;

FIG. 55 is a side view of the worm gear of FIG. 45;

FIG. 56 is a rear view of the worm gear of FIG. 45;

FIG. 57 is a perspective view of the port side of the proximal side enclosure of FIG. 45;

FIG. 58 is a rear view of the proximal side enclosure of FIG. 45;

FIG. 59 is a perspective view of the starboard side of the proximal side enclosure of FIG. 45;

FIG. 60 is a starboard side view of the proximal side enclosure of FIG. 45;

FIG. 61 is a perspective view of the port side of the distal side enclosure cover of FIG. 45;

FIG. 62 is a port side view of the distal side enclosure cover of FIG. 45;

FIG. 63 is a starboard side view of the window shade of FIG. 1 installed in a window frame, the window shade and the window frame being arranged in a normal roll configuration;

FIG. 64 is a partial sectional view of the window shade of FIG. 63, along line 64-64;

FIG. 65 is a sectional view of the clutch device and tube assembly of FIG. 64, along line 65-65;

FIG. 66 is a sectional view of the clutch device and tube assembly of FIG. 64, along line 66-66;

FIG. 67 is a sectional view of the clutch device and tube assembly of FIG. 64, along line 67-67;

FIG. 68 is a sectional view of the clutch device and tube assembly of FIG. 64, along line 68-68;

FIG. 69 is a perspective view of the clutch device of FIG. 64;

FIG. 70 is another perspective view of the clutch device of FIG. 64;

FIG. 71 is an exploded view of the clutch device of FIG. 64;

FIG. 72 is a partial sectional view of the bottom bar and screen of flexible material of FIG. 1.

FIG. 73 is a sectional view of the bottom bar and screen of flexible material of FIG. 72, along line 73-73;

FIG. 74 is a perspective view of the port side of the bottom bar and screen of flexible material of FIG. 4.

FIG. 75 is another perspective view of the port side of the bottom bar and screen of flexible material of FIG. 4.

FIG. 76 is a top view of the window shade apparatus of FIG. 1 installed in a first configuration.

FIG. 77 is a top view of the window shade apparatus of FIG. 1 installed in a second configuration.

FIG. 78 is a top view of the window shade apparatus of FIG. 1 installed in a third configuration.

FIG. 79 is a top view of the window shade apparatus of FIG. 1 installed in a fourth configuration.

FIG. 80 is a sectional view of FIG. 76, along line 80-80;

FIG. 81 is a sectional view of FIG. 77, along line 81-81;

FIG. 82 is a sectional view of FIG. 78, along line 82-82;

FIG. 83 is a sectional view of FIG. 79, along line 83-83;

FIG. 84 is a perspective view of an elastomeric spline being installed in a concavity to fix a fabric valance to the cassette of FIG. 6;

FIG. 85 is a port side view of the cassette of FIG. 84 after the elastomeric spline has been installed to fix the fabric valance to the cassette;

FIG. 86 is a perspective view of an elastomeric spline being installed to fix a fabric sheet to the bottom bar cover track of FIG. 72;

FIG. 87 is a port side view of the bottom bar cover track of FIG. 86 after the elastomeric spline has been installed to fix the fabric sheet to the bottom cover track;

FIG. 88 is a perspective view of a hand tool for arranging a fold in a fabric sheet within in a concavity for insertion of an elastomeric or rigid spline that anchors the fold within the concavity;

FIG. 89 is a plan view of the hand tool of FIG. 88;

FIG. 90 is another perspective view of the hand tool of FIG. 88;

FIG. 91 is a starboard side view of the hand tool of FIG. 88;

FIG. 92 is a port side view of the hand tool of FIG. 88;

FIG. 93 shows a tip of the hand tool of FIG. 88 positioning a fabric sheet into the superior cavity of a cassette;

FIG. 94 shows the hand tool of FIG. 88, traversing the superior cavity and progressively expanding a fold in the fabric sheet with a first raised edge, the first raised edge having a progressively larger cross-section from the front to the back of the hand tool;

FIG. 95 shows the hand tool traversing the proximal cavity of a bottom bar cover track and expanding the fabric therein with a second raised edge, the second raised edge having a progressively larger cross-section from the front to the back of the tool, the second raised edge having a smaller cross-sectional profile than the first raised edge;

FIG. 96 shows a spline having a first square cross-section;

FIG. 97 shows a spline having a second square cross-section, the second square cross-section being larger than the first square cross-section of FIG. 96;

FIG. 98 shows a spline circular cross-section of a rigid spline;

FIG. 99 shows a spline having a triangular cross-section;

FIG. 100 shows a spline having a hexagonal cross-section;

FIG. 101 shows a spline having an octagonal cross-section;

FIG. 102 shows a spline having a 4-point star cross-section;

FIG. 103 shows a spline having a 6-point star cross-section;

FIG. 104 is a perspective view of a first embodiment of an adjustable tube bracket arranged in the port side of the cassette of FIG. 4;

FIG. 105 is another perspective view of the adjustable tube bracket of FIG. 104, the adjustable tube bracket being in a collapsed configuration;

FIG. 106 is another perspective view of the adjustable tube bracket of FIG. 104, the adjustable tube bracket being in an expanded configuration;

FIG. 107 is a perspective view of a second embodiment of an adjustable tube bracket arranged in the port side of the cassette of FIG. 4;

FIG. 108 is another perspective view of the adjustable tube bracket of FIG. 107, the adjustable tube bracket being in a collapsed configuration; and

FIG. 109 is another perspective view of the adjustable tube bracket of FIG. 107, the adjustable tube bracket being in an expanded configuration.

### DESCRIPTION

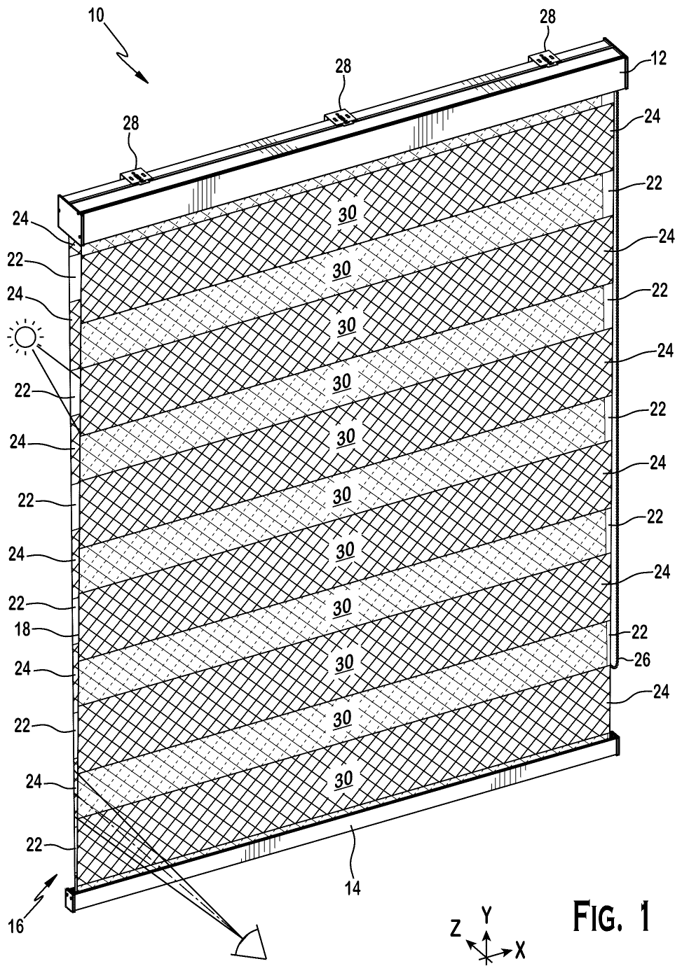

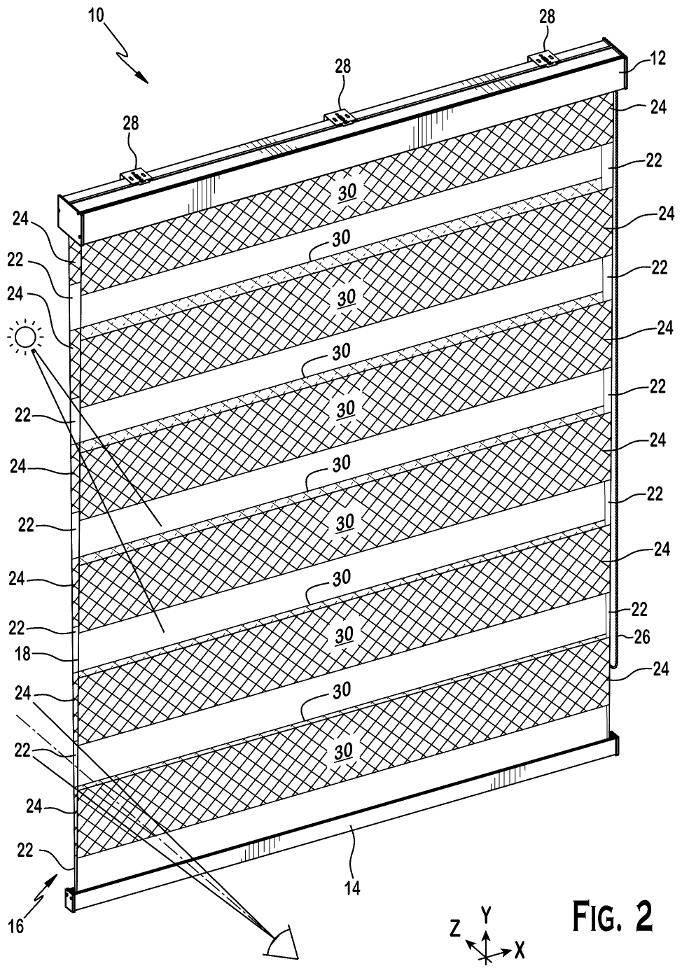

FIG. 1 is a perspective view of an illustrative window shade apparatus 10, the window shade apparatus including a proximal sheet 18 of flexible material and a distal sheet 20 of flexible material, the window shade 16 being in a lowered position and arranged in a first configuration (e.g., a light filtering configuration). FIG. 2 is a perspective view of the window shade apparatus 10, the window shade 16 being in a lowered position and arranged in a second configuration (e.g., a light transmitting configuration). FIG. 3 is a perspective view of the window shade apparatus 10, the window shade 16 being in a lowered position and arranged in a third configuration (e.g., a light blocking configuration).

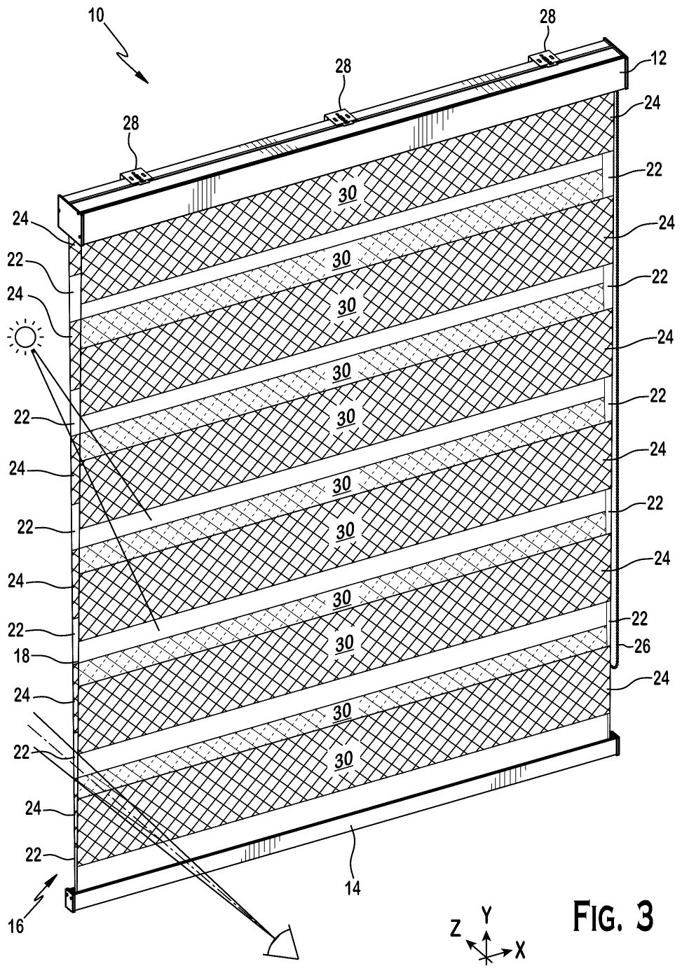

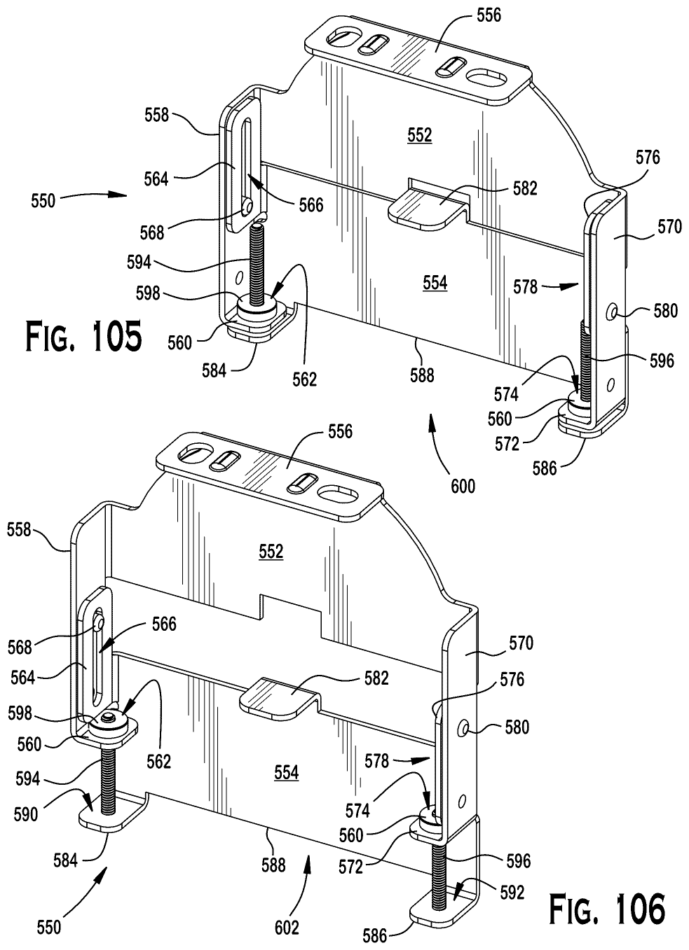

FIG. 4 is an exploded view of the window shade apparatus 10. The window shade apparatus 10 may include a cassette 12, a bottom bar 14, a shade (or screen of flexible material) 16, a major tube 36, a minor tube 38, a clutch 42, an idler-adjustable stop (IAS) device 44, and a tilting gear (or differential adjustment (DA) device) 46. Alternatively, the clutch 42 may be replaced with a tube motor. Generally, the differential adjustment (DA) device 46 may be used to selectively align the proximal layer 18 and the distal layer 20 of the shade 16; whereas the idler-adjustable stop (IAS) device may be used to selectively regulate the full deployment length of the shade 16. Additionally, the window shade apparatus 10 may include tube brackets 50, 52 for securing the major tube to the cassette. Referring to FIGS. 105-109, two embodiments of adjustable tube brackets 550, 604 are disclosed. Accordingly, one (or both) of the tube brackets 50, 52 in FIG. 4 may be replaced with an adjustable tube bracket 550, 604 to facilitate leveling of the major tube 36 and window shade 16.

Referring to FIGS. 1-4, the window shade apparatus 10 may be a double-layer shade (or zebra shade). The window shade 16 may include a proximal layer 18 and a distal layer 20 of fabric material 16. The two layers may be formed from a single sheet of fabric material. The fabric material may include alternating regions (e.g., bands) of light transmitting fabric 22 and light blocking fabric 24. For example, light transmitting fabric may include flexible materials which exhibit transparent or translucent light transmitting properties. By contrast, light blocking fabric may include flexible materials which exhibit an opaque or a lesser degree of opacity.

As shown in FIGS. 4 and 76-83, one end of the fabric material sheet may be wound on a roller tube (or major tube) 36 and the other end of the fabric material sheet may be spooled on to an adjacent adjustment tube (or minor tube) 37. As fabric material is wound on or off the major tube, alternating regions of light transmitting fabric 22 and light blocking fabric 24 on the proximal and distal layers may move past each other. When the shade is fully lowered, the alternating regions of may not be aligned as shown in FIG. 3. The differential adjustment (DA) device 46 may selectively align the proximal layer 18 and the distal layer 20 of the shade 16 by spooling additional fabric sheet from the shade (or unspooling additional fabric for the shade) until the desired alignment between the proximal layer 18 and the distal layer 20 of the shade 16 are achieved. For instance, in a preferred embodiment, 1 revolution of the minor tube 38 may spool (or unspool) a length of about 1.15 inches of fabric material 20. The clutch (or tube motor) may then be used to unspool additional fabric material from (or spool additional material onto) the major tube 36 until the bottom bar is in a fully deployed position (e.g., fully lowered). Although the desired alignment may be lost when the adjustments are complete, the desired alignment may be incrementally improved. Accordingly, the process may be repeated iteratively until the desired alignment is achieved when the bottom bar is in the fully deployed position.

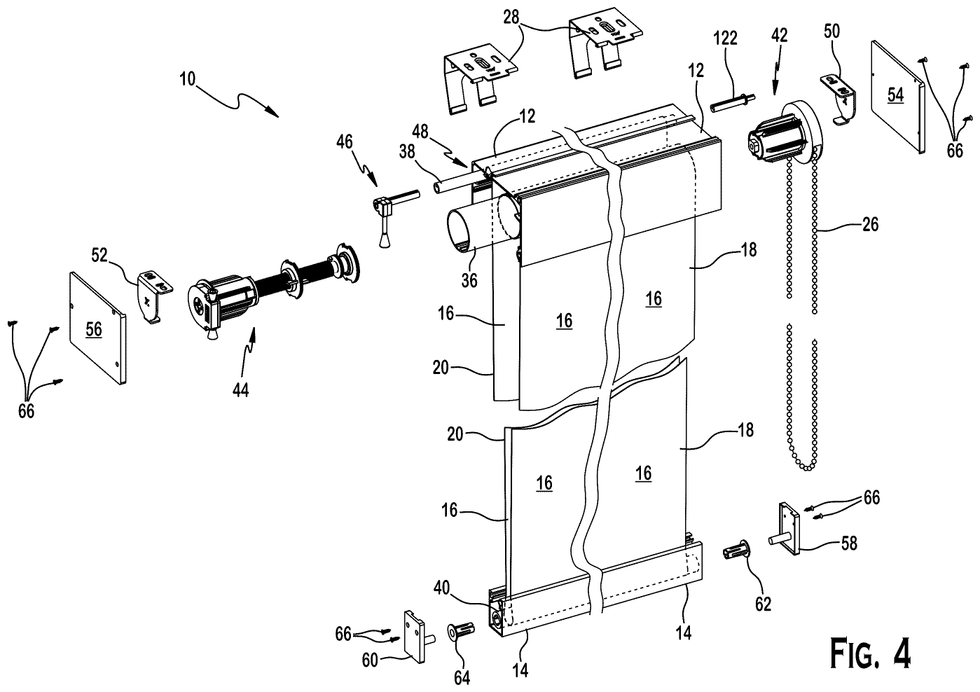

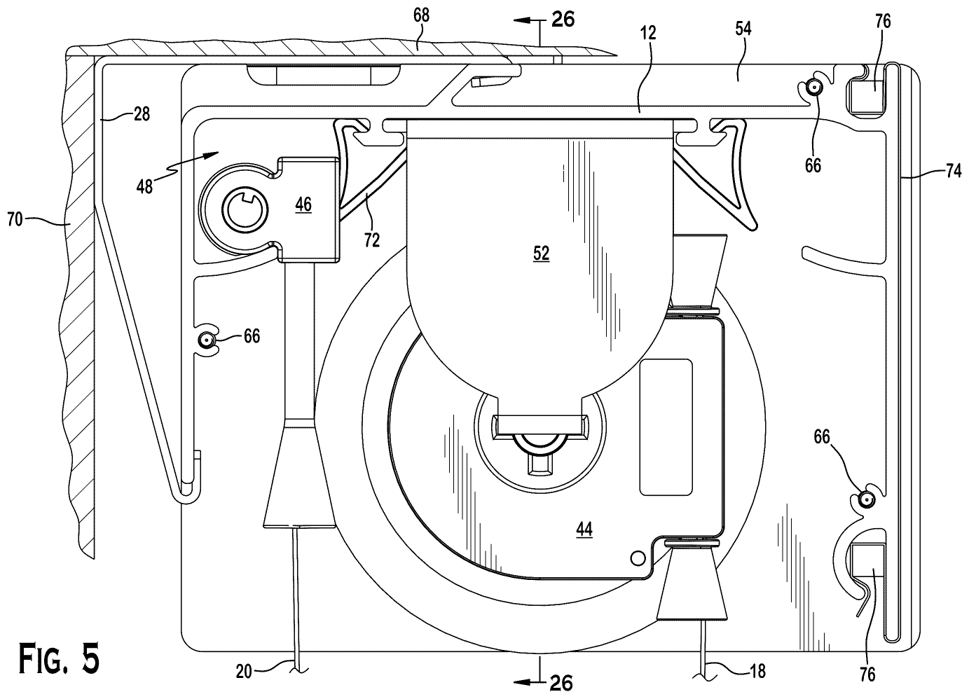

As shown in FIG. 5, the window shade apparatus 10 may be installed in a normal roll configuration. More particularly, the cassette 12 may be hooked to a cassette mounting bracket(s) 28 that is secured to the window frame 15. Additionally, a tube bracket 52 may be used to secure the roller shade assembly to the cassette 12. The roller shade assembly may include the major tube 36, the clutch (or tube motor) 42, and the IAS device 44. Additionally, the DA device 46 may be housed in a minor tube retention pocket 48.

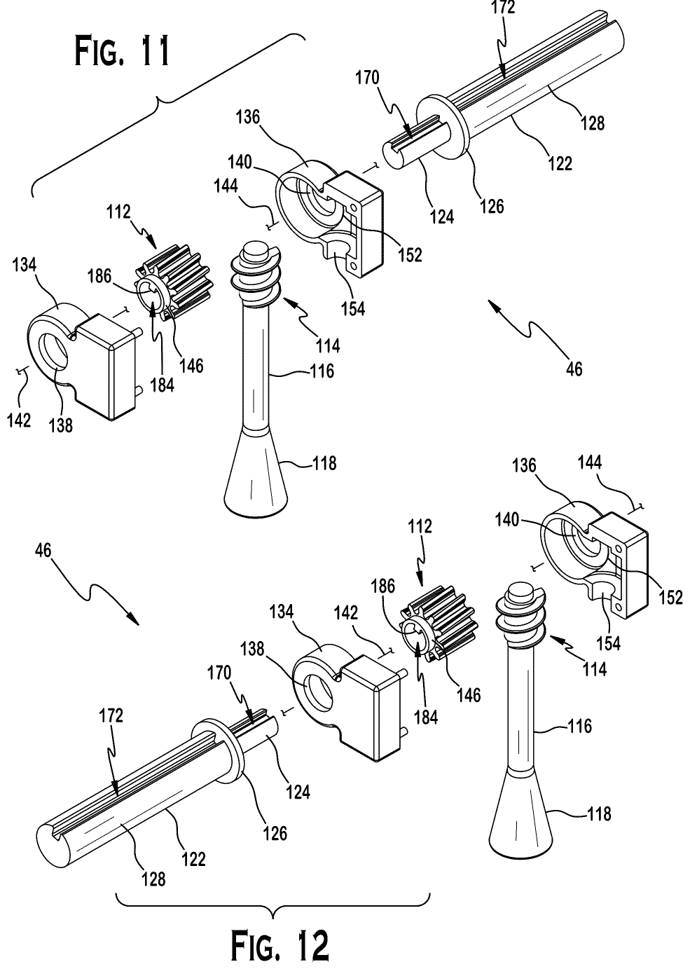

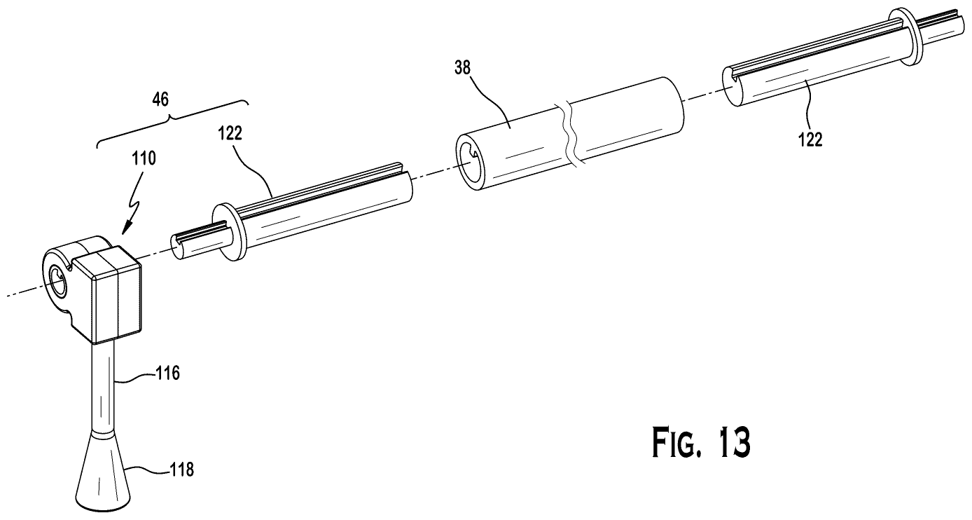

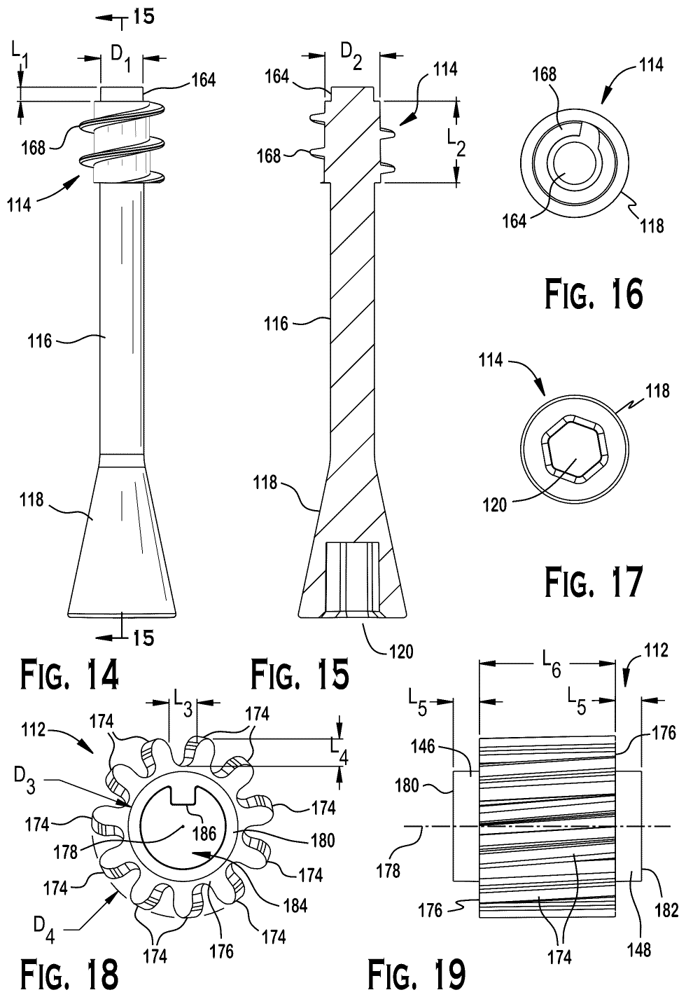

Referring to FIG. 13, the DA device 46 may be a component of the differential adjustment assembly 45. The differential adjustment assembly may include the DA device 46, the minor tube 38, and a connecting rod 122 that may laterally align and stabilize the minor tube 38 within the minor tube retention pocket 48. Generally, the minor tube may have an outer diameter of between about 0.3 inches and 0.6 inches. For example, the minor tube may have an outer diameter of approximately 0.375 inches. Additionally, the minor rod may be an aluminum alloy extrusion with a nil finish.

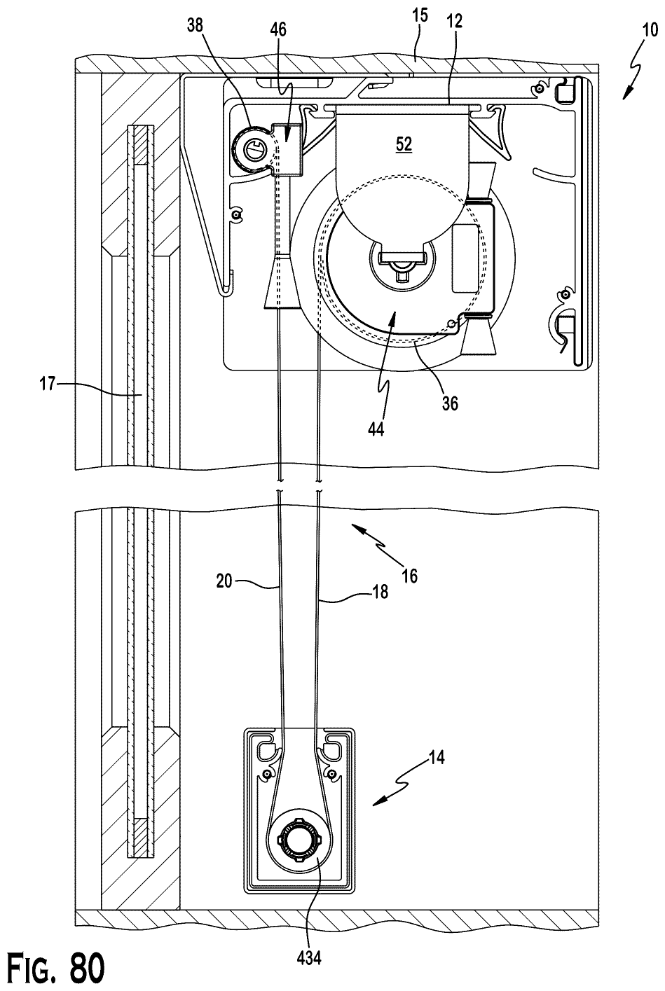

As shown in FIG. 6 and FIG. 7, the cassette 12 may include a proximal minor tube receptacle 92 and distal minor tube receptacle 94. In this embodiment, the minor tube retention pocket 48 may be formed by the distal minor tube receptacle 94 and a minor tube retention clip 72. See also, FIGS. 80 and 82. By contrast, in other embodiments, the minor tube retention pocket 48 may be formed by the proximal minor tube receptacle 92 and a minor tube retention clip 72. See e.g., FIGS. 81 and 83.

Referring to FIG. 7, the cassette 12 may include a front wall 78, a top wall 80, and a rear wall 82, as well as a proximal curved ledge 84 extending from the front wall. Additionally, the cassette may include a proximal rail 88 and a distal rail 90 extending from the top wall, and a distal curved ledge 86 extending from the rear wall. The proximal curved ledge, the front wall, and the top wall may cooperate to form the proximal minor tube receptacle 92. Similarly, the distal curved ledge, the rear wall, and the top wall may cooperate to form the distal minor tube receptacle 94. As previously shown, the DA device 46 may be arranged in the minor tube retention pocket 48, the minor tube retention pocket 48 being cooperatively formed by the distal minor tube receptacle 94 and a minor tube retention clip 72 that is secured to the distal rail 90. The cassette 12 may further include an external hook 96 on the top wall, a superior concavity 98 and an inferior concavity 100 abutting the front wall, as well as a fastener receiving receptacle 102 on the front wall, a fastener receiving receptacle 104 on the top wall, and a fastener receiving receptacle 106 on the rear wall.

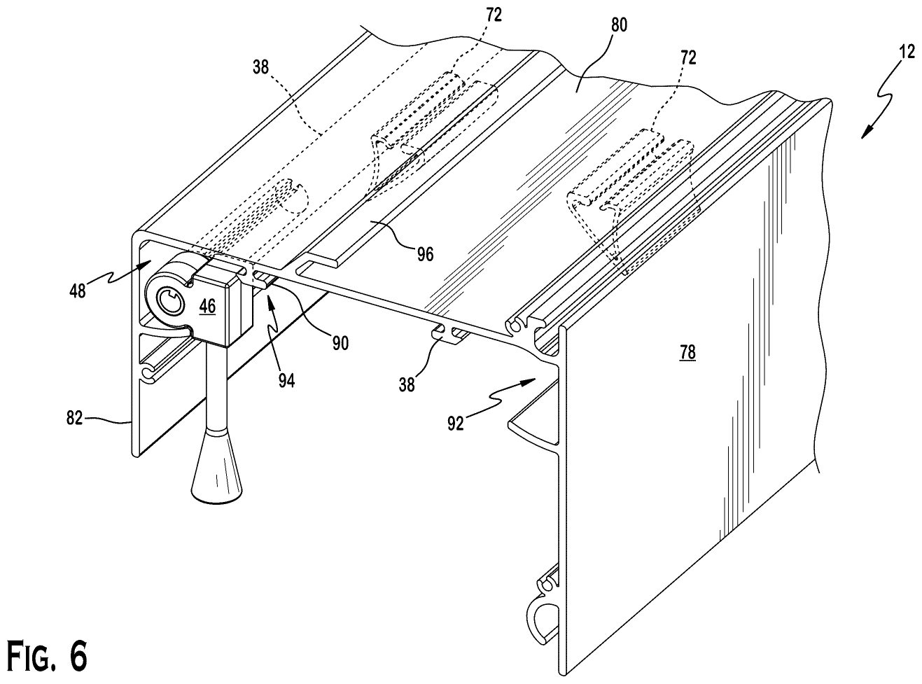

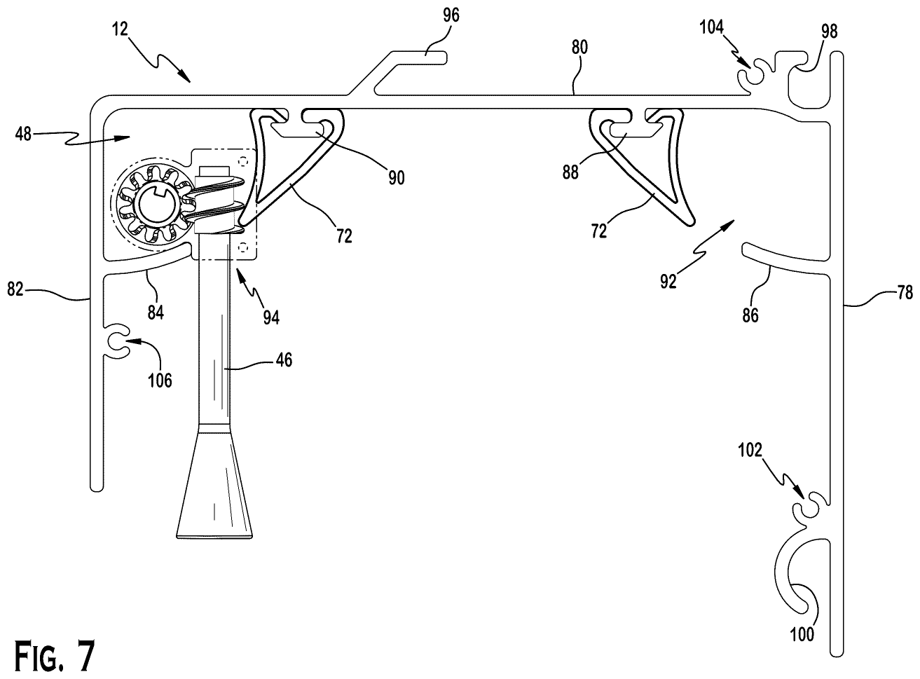

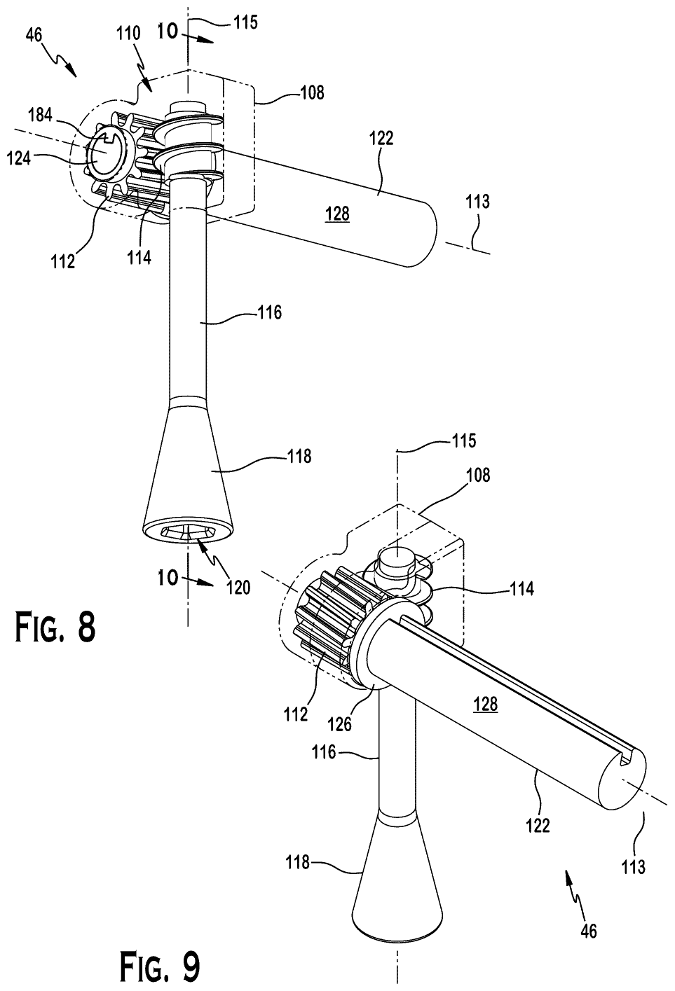

Referring to FIGS. 8, 9, and 10 the differential adjustment (DA) device 46 may include a housing 108 and a worm drive 110 arranged in the housing. The worm drive 110 may include a worm gear 112 and a worm screw 114. For instance, the worm gear 112 may include a right hand helical gear, and the worm screw 114 may include a right hand screw thread. In a preferred embodiment of the worm drive 100, 11 full turns of the worm screw 114 produces 1 full turn of the worm gear 112.

Referring to FIGS. 11, 12 and 15-17, the worm screw 114 may include a shaft 116 and a distal segment 164. In a preferred embodiment, the shaft 116 may include a frustoconical end 118. The frustoconical end further may include a tool fitting 120. For example, the tool fitting may be a hex fitting (e.g., an M4 hex fitting). Although a shaft with a frustoconical end may be preferred, the end of the shaft may have another shape (e.g., a circular cylinder, a hex shaped cylinder, or a sphere). Alternately the end of the shaft may include a knob. In a preferred embodiment, however, the worm screw may have two threads. Moreover, the worm screw may have a pitch of 0.11 inches for 3 revolutions. Exemplary dimensions for the worm screw are presented in Table 1 (below).

TABLE 1
Illustrative DA Device Worm Screw and Worm Gear Dimensions

| | | Length | |
|---|---|---|---|
| Dimension | Description | (inches) | FIG. |
| L1 | Distal segment of worm screw (164), length | 0.045 | 14 |
| L2 | Worm screw (114), length | 0.26 | 15 |
| L3 | Pitch (tooth face-to-tooth face), length | 0.054 | 18 |
| L4 | Tooth depth (top of tooth-to-root), length | 0.052 | 18 |
| L5 | Length of boss (146, 148) | 0.05 | 19 |
| L6 | Length of helical gear (174), length | 0.26 | 19 |
| CD1 | Center distance of worm drive, length | 0.26 | 10 |
| D1 | Diameter of screw shaft (164), length | 0.135 | 14 |
| D2 | Diameter of worm screw (114), length | 0.175 | 15 |
| D3 | Outer diameter of boss (146, 148), length | 0.21 | 18 |
| D4 | Outer diameter of helical gear (174), length | 0.349 | 18 |

Notes:
(a) Illustrative values for length and diameter dimensions are presented to the least significant digit without rounding but within standard manufacturing tolerances.

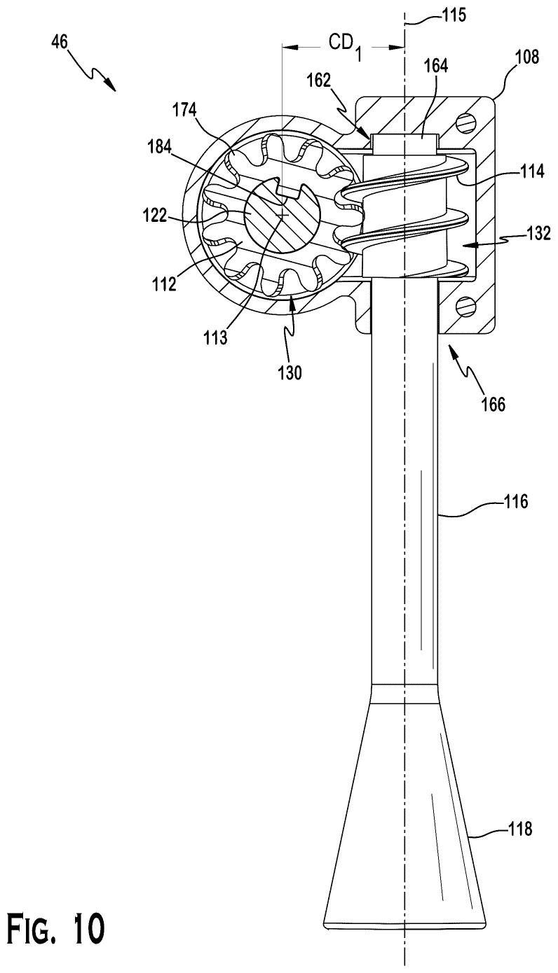

Referring to FIGS. 10-12 and 18-19, the worm gear 112 may be a helical gear. More particularly, a plurality of gear teeth 174 may be arranged about a cylindrical body 176. The cylindrical body 176 may include a central axis 178 which may form a rotational axis of the worm gear. A first boss 146 may extend from a first side (or port side) of the worm gear and a second boss 148 may extend from a second side (or starboard side) of the worm gear. A cavity may extend from the end of the port side boss to the end of the starboard side boss to form a tubular cylindrical body. The tubular cylindrical body may include a bar which projects into the cavity. In the preferred embodiment, the worm gear may be a helical gear with 11 teeth. More particularly, the helical gear may have a pitch of 12 inches for 0.4 revolutions. Moreover, the helix angle of the worm gear may be 14.4 degrees. Exemplary dimensions for the worm gear are presented in Table 1 (above).

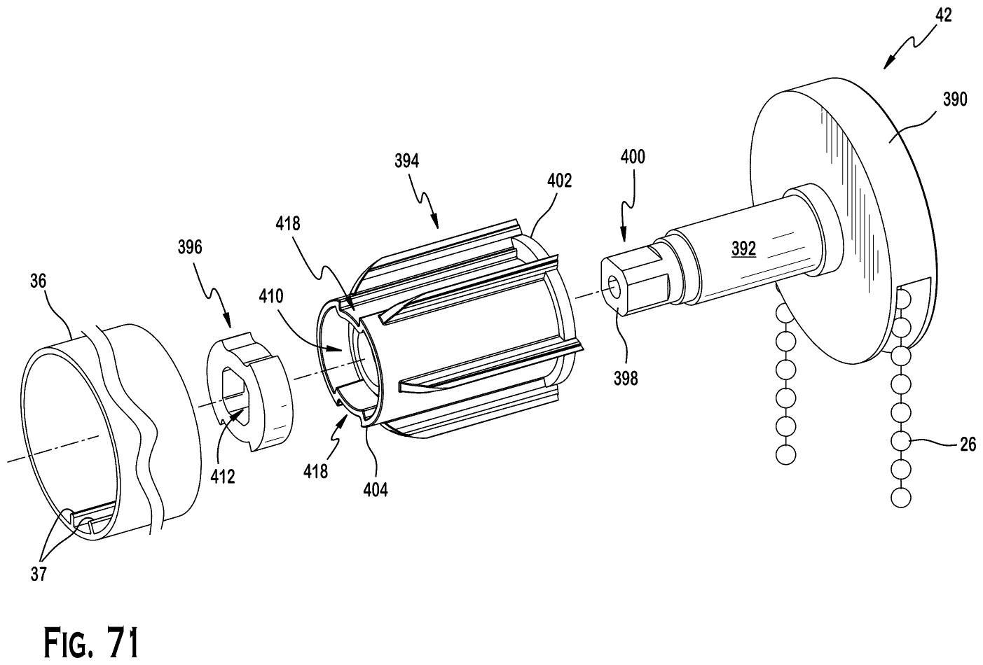

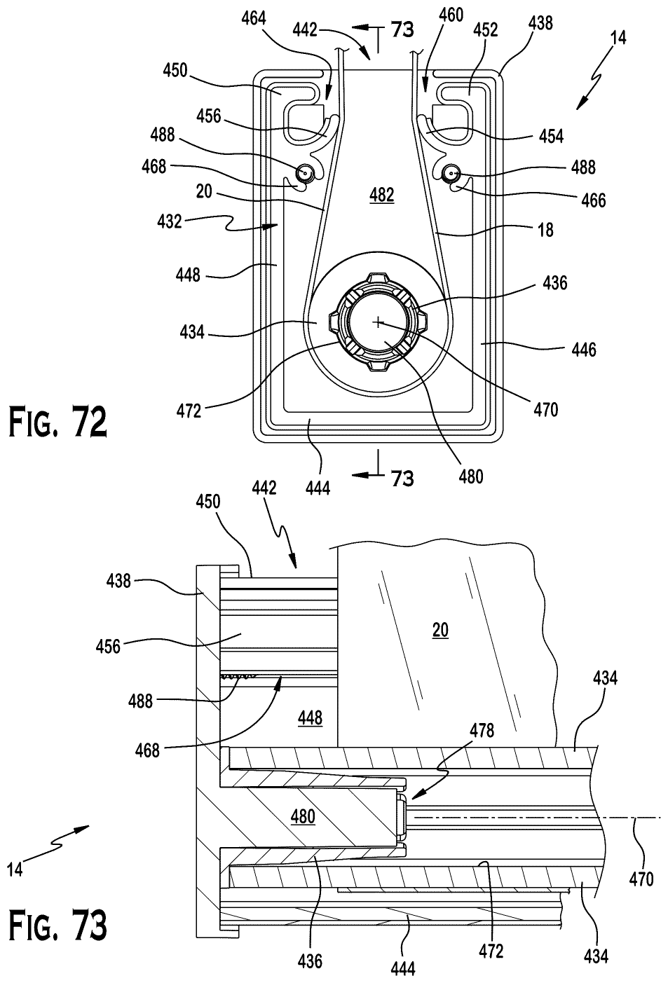

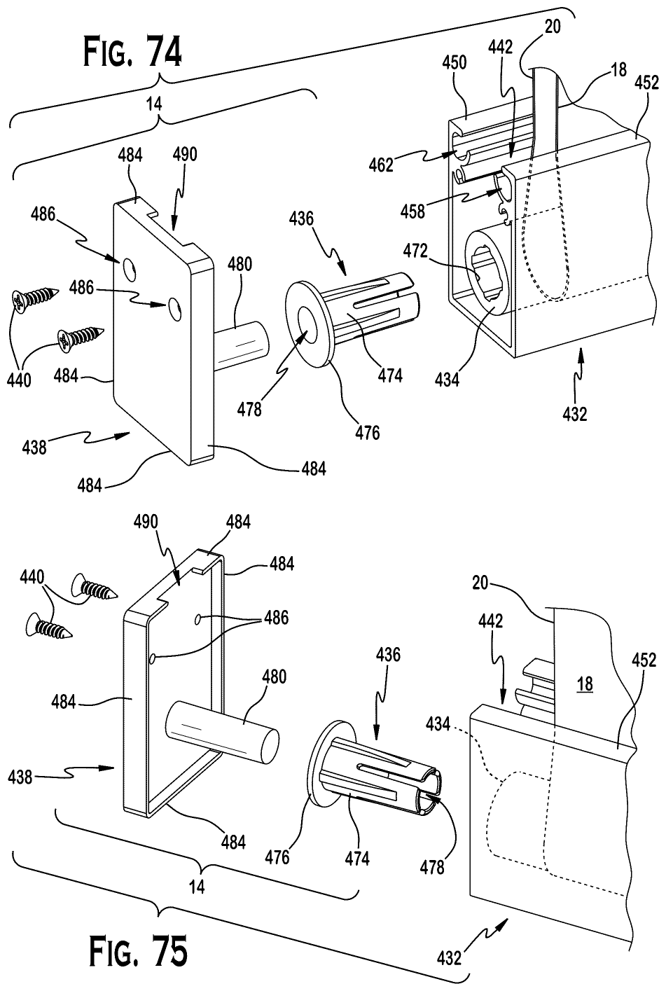

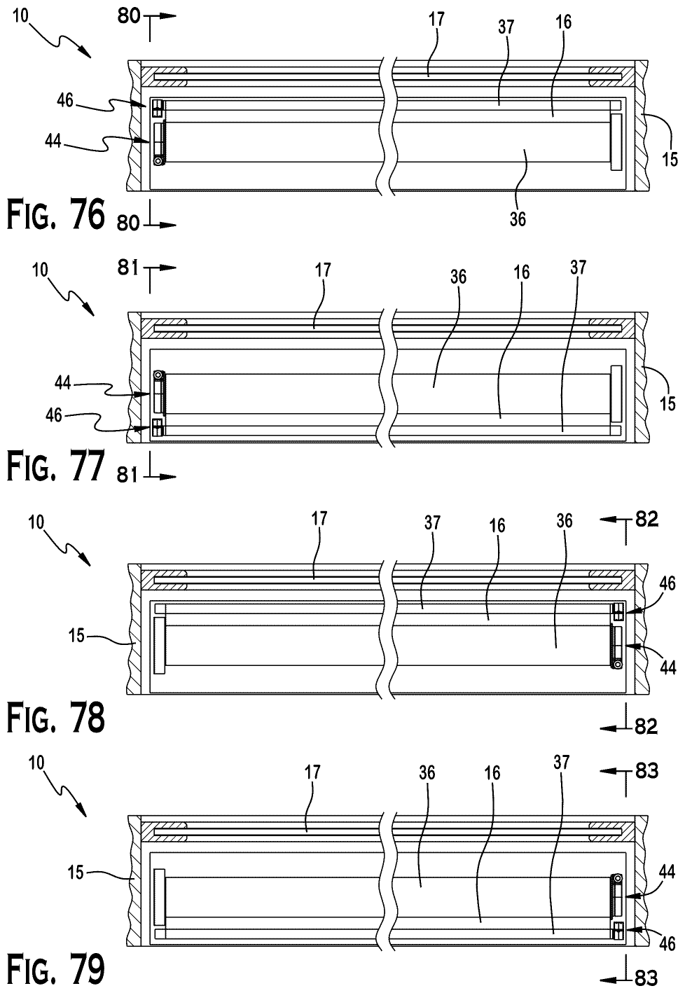

Referring to FIG. 8 and FIG. 9, the DA device 46 may include a connecting rod 122. As shown in FIGS. 10, and 11-12, the connecting rod 122 may include a stem 124 that is telescopically received in the worm gear. The connecting rod 122 further may include a flange 126 and a drive shaft 128. Moreover, the stem 124 may include a notch 170 and the drive shaft may include a longitudinal groove 172. Referring to FIGS. 11-12, the stem 124 may be received in the cavity 184. More particularly, the stem may mate with the cavity such that the bar is slidably received within the notch and the flange abuts the gear case. As shown in FIGS. 4, 6, 9 and 11, the connecting rod may be arranged in the cavity such that the drive shaft 128 may be positioned on starboard side of the gear case. (see also FIG. 76 and FIG. 80) Alternatively, as shown in FIGS. 10, 77, and 81, the connecting rod may be arranged in the cavity such that the drive shaft 128 may be positioned on port side of the gear case.

Referring to FIG. 10, the worm drive 110 may be contained within a housing (or gear case) 108. The gear case 108 may include a worm gear receptacle 130 and a worm screw receptacle 132. The worm gear receptacle 130 may contain the worm gear 112, and the worm screw receptacle 132 may contain the worm screw 114. The worm gear 112 may rotate about a drive axis 113 and the worm screw may rotate about a screw axis 115. Generally, the drive axis 113 and the screw axis 115 may be oriented in separate orthogonal directions. In a preferred embodiment, the distance between the drive axis and the screw axis (or central distance) may be about 0.26 inches. Referring to FIG. 11 and FIG. 12, the gear case 108 may include a port side casing 134 and a starboard side casing 136. The port side casing housing and the starboard side casing may mate to form the gear case. In a preferred embodiment, port gear housing and starboard gear housing may combine to form a press fit enclosure, as shown in FIGS. 20-22.

As shown in FIGS. 20-22, the worm gear receptacle 130 may include a first circular band 138 on the port side gear casing and a second circular band 140 on the starboard side gear casing. The first circular band 138 may have a first central axis 142 and the second circular band 140 may have a second central axis 144. When the port side casing 134 and the starboard side casing 136 are assembled, the first and second central axes 142, 144 may be coincident. Moreover, referring to FIGS. 8-10, the first and second central axes 142, 144 may define the drive axis 113 about which the worm gear 112 rotates. Additionally, the first circular band 140 may form a first bearing for a first boss 146 on the worm gear 112, and the second circular band 140 may form a second bearing for a second boss 148 (see e.g. FIG. 16) on the other side of the worm gear.

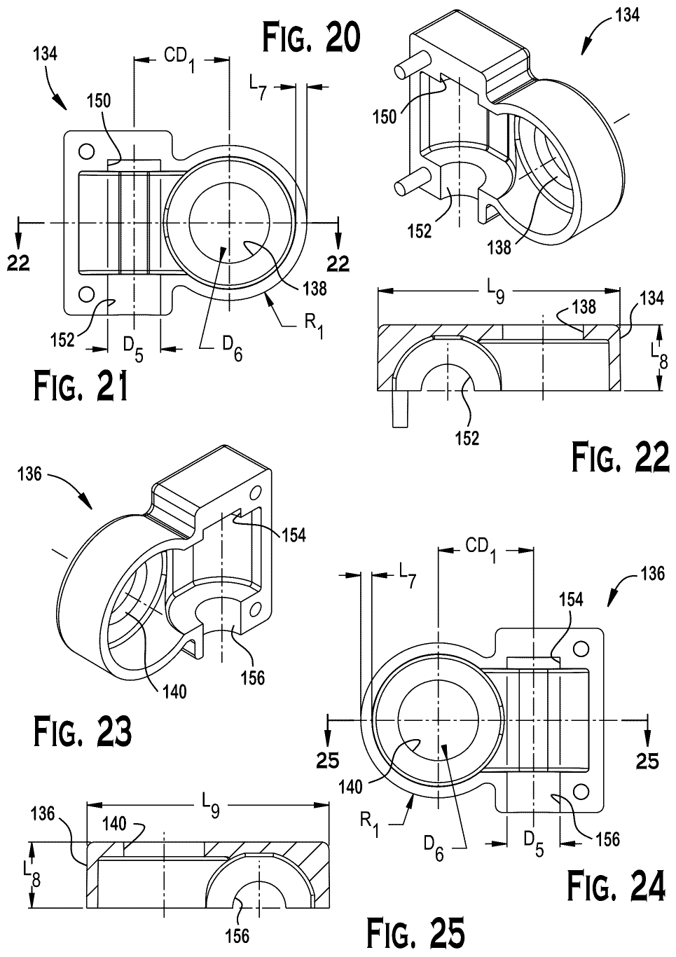

Moreover, referring to FIGS. 20-21, the worm screw receptacle 132 may include a first superior semicircular band 150 and a first inferior semicircular band 152 on the port side casing 134, as well as a second superior semicircular band 154 and a second inferior semicircular band 156 on the starboard side casing 136 (see e.g., FIGS. 23-24). Also, when the port side casing 134 and the starboard side casing 136 are assembled, the first superior semicircular band 150 and the second superior semicircular band 154 may form a third circular band. Similarly, the first inferior semicircular band 152 and the second inferior semicircular band 156 may form a fourth circular band. The third circular band may have a third central axis 158 and the fourth circular band may have a fourth central axis 160. The third and fourth central axes may be coincident.

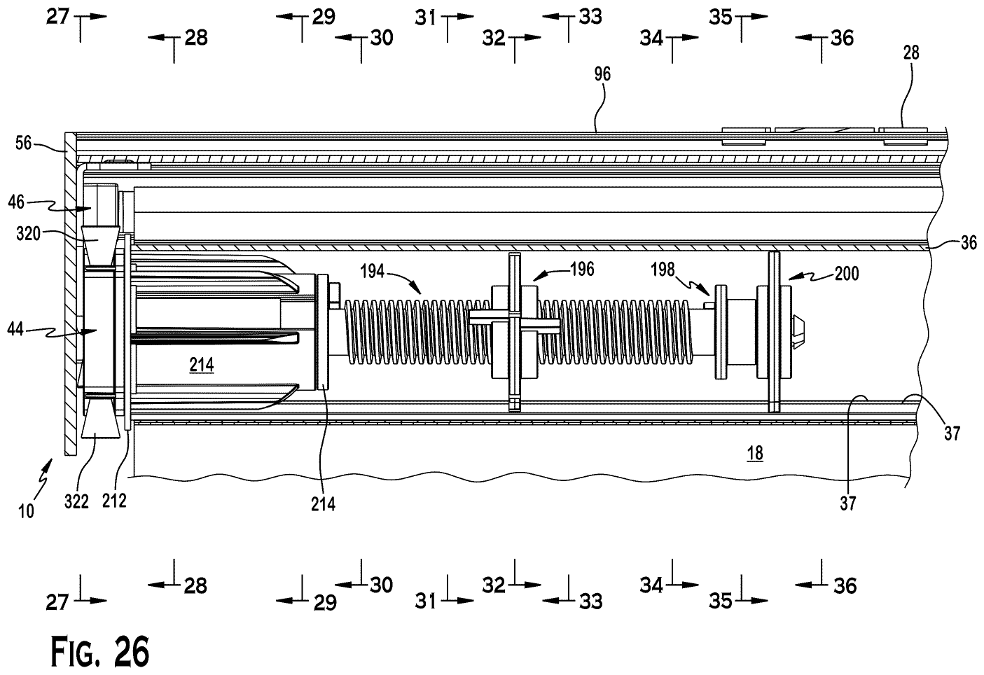

Referring to FIGS. 20 and 23, the third and fourth central axes 158, 160 may define the screw axis 115 about which the worm screw 114 may be rotated. Additionally, the third circular band 162 may form a third bearing for a distal segment 164 of the worm screw and the fourth circular band 166 may form a third bearing for the shaft 116 of the worm screw. Referring to FIG. 20-25, exemplary dimensions for the port side gear casing and the starboard side gear casing are presented in Table 2.

TABLE 2
Illustrative DA Device Gear Case Dimensions

| Dimen- | | Length | |
|---|---|---|---|
| sion | Description | (inches) | FIG. |
| L7 | Thickness of helical gear receptacle, length | 0.03 | 21 |
| L8 | Width of side casings (134, 136), length | 0.18 | 22, 25 |
| L9 | Length of side casings (134, 136), length | 0.66 | 22, 25 |
| CD1 | Center distance of worm drive, length | 0.26 | 21 |
| R1 | Radius of helical gear receptacle, length | 0.212 | 21, 24 |
| D5 | Diameter of worm screw bearing | 0.145 | 23, 24 |
| | (154, 156), length | | |
| D6 | Diameter of worm gear bearing | 0.22 | 21, 24 |
| | (138, 140), length | | |

Notes:
(a) Illustrative values for length and diameter dimensions are presented to the least significant digit without rounding but within standard manufacturing tolerances.

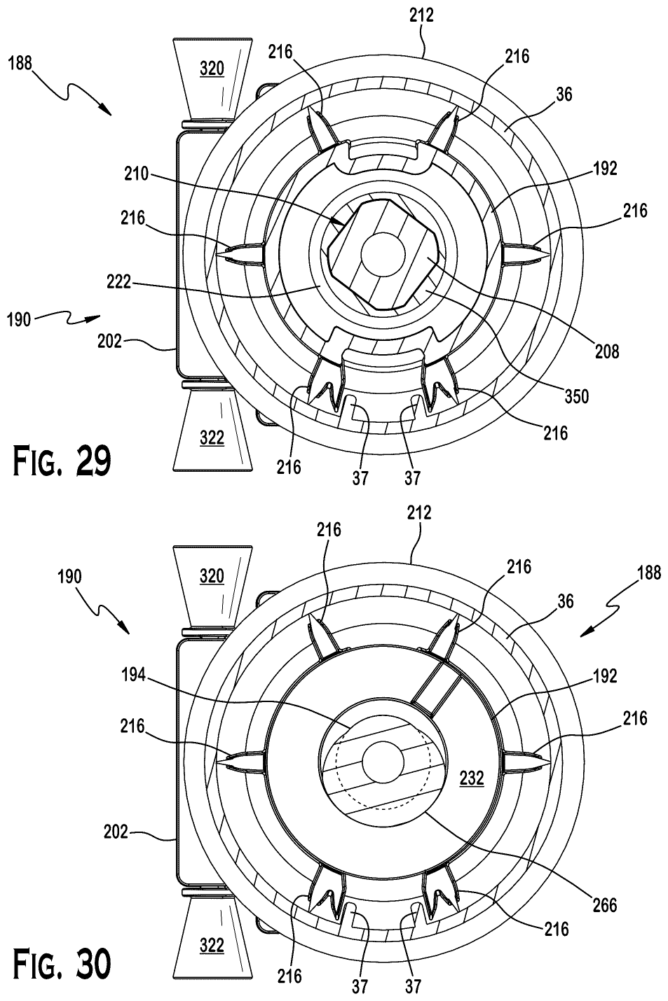

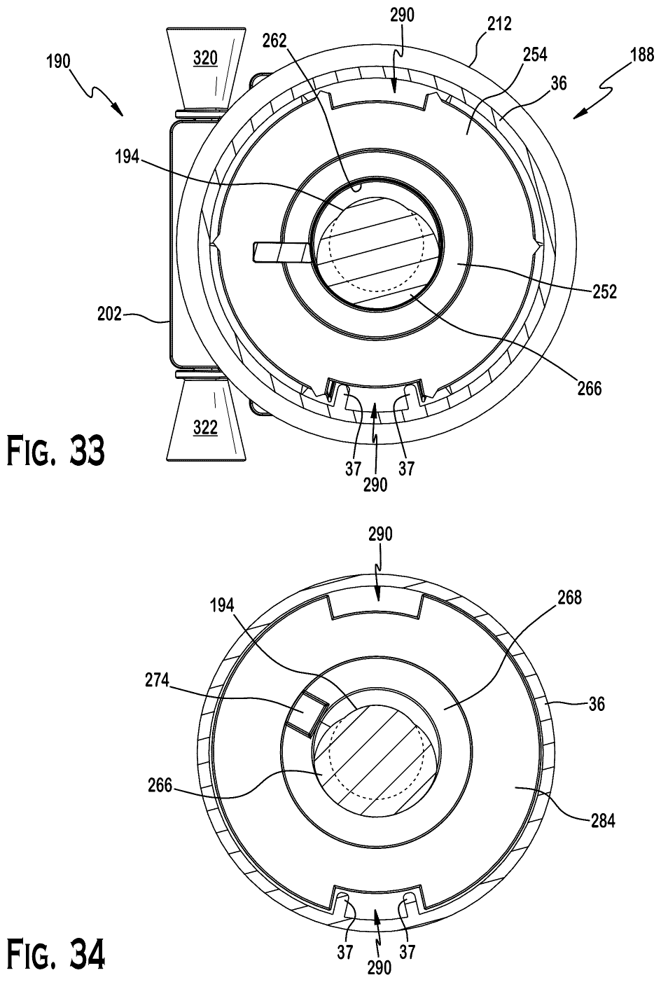

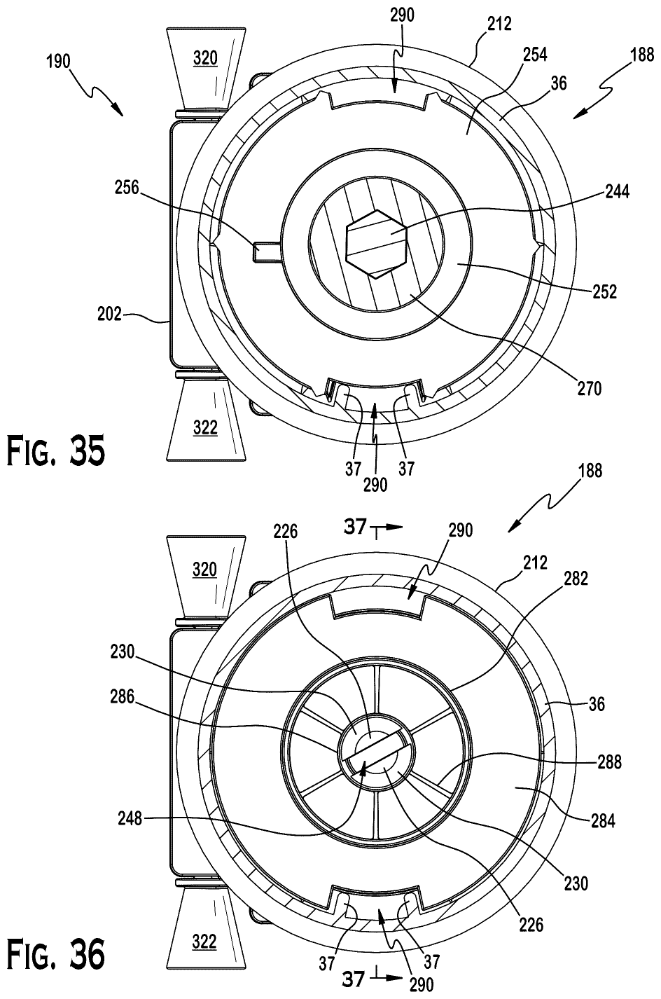

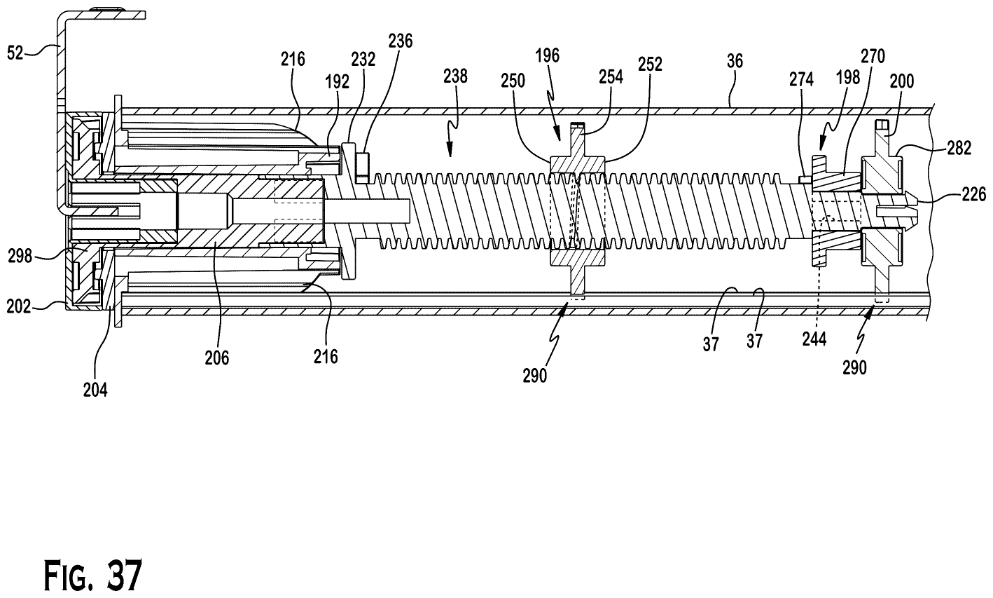

Referring to FIGS. 26-37 and 40-44, an exemplary adjustable stop apparatus (ASA) 188 for a window shade is disclosed. The ASA 188 may include an exemplary idler and adjustable stop (IAS) device 44, as well as a roller tube (or major tube) 36 for receiving a screen of fabric material for the window shade. For example, the major tube may be a 1.5-inch diameter tube. Generally, the major tube may be an aluminum alloy extrusion with nil finish. Other metal alloys or polymer materials, however, may be used provided the resulting tube has similar weight and structural properties. The major tube may include a pair of parallel rails 37 on the inside surface.

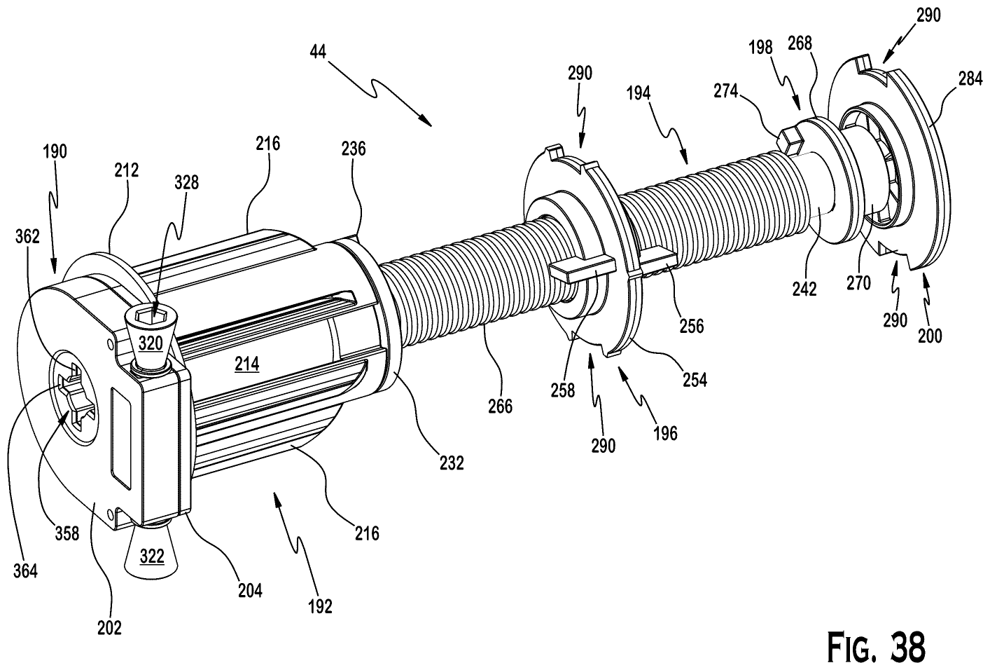

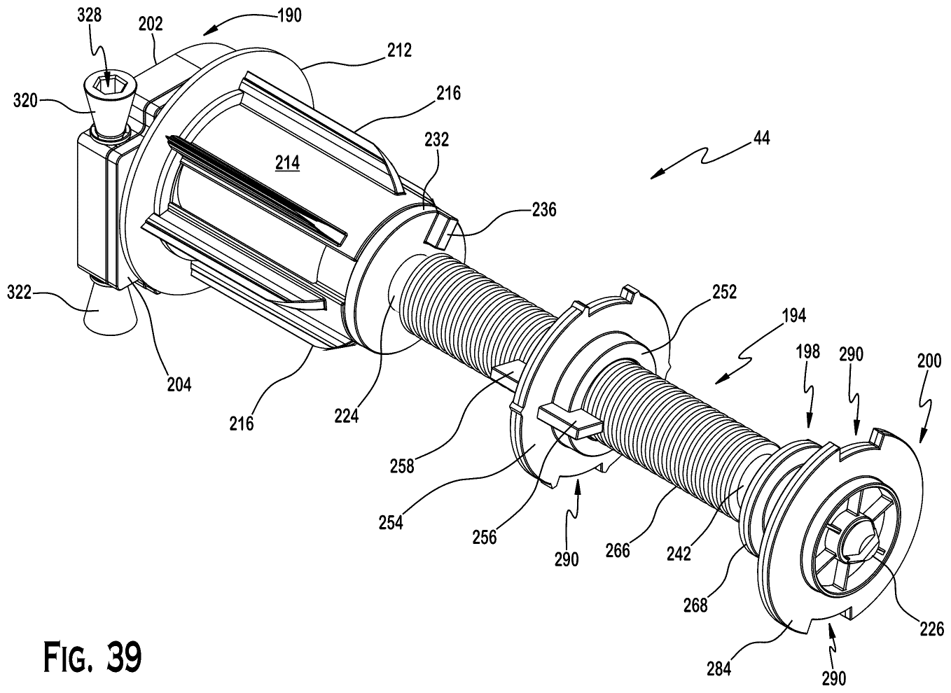

Referring to FIGS. 38-39, the IAS device 44 may include a gear housing 190, an idler body 192, a rod 194, an intermediate ring 196, a distal stop 198, and a distal ring 200. Referring to FIGS. 40-41, the gear housing 190 may include a proximal worm drive casing 202, a distal worm drive casing 204, an axle 206, and a worm drive transmission shaft 208. The distal portion of the worm drive transmission shaft may further include a power takeoff (PTO) fitting 210. The idler body 192 may include a circular base 212, and a cylindrical body 214 projecting from the circular base. The cylindrical body 214 may include a plurality of radial fins 216 extending from the circular base toward the distal end 218 of the cylindrical body. The idler body 192 may further include a central passage 220 extending from the circular base 212 to the distal end 218 of the cylindrical body. A proximal portion of the central passage 220 may be configured and dimensioned to be telescopically received over the gear housing axle 206 such that the circular base 212 of the idler body may abut the distal worm drive casing 204 and the idler body 192 may be free to rotate about the gear housing axle. Additionally, a distal portion of the central passage 220 may form a seat for the proximal end 222 of the rod. The proximal end 222 of the rod further may include an annular stem 224, which may be configured and dimensioned to be telescopically received in the distal portion of the central passage 220. Moreover, the interior sidewall 226 of the annular stem 224 may be configured and dimensioned to telescopically receive and engage with the PTO fitting 210 on the worm drive transmission shaft 208.

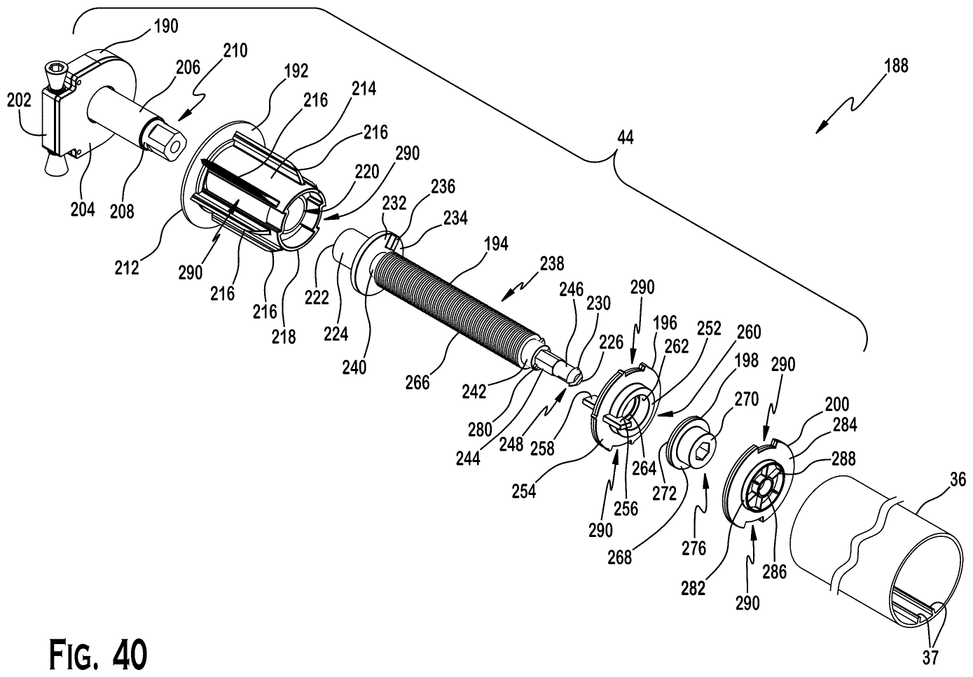

Generally, the rod 194 may include a proximal end 222, a distal end 226, and a central axis 228 extending from the proximal end to the distal end. The proximal end 222 may include the annular stem, and the distal end 226 may include a tip 230. Additionally, the rod may include an annular flange 232 next to the annular stem 224. The distal face 234 of the annular flange 232 may include a rectangular block 236. The rod further may include a threaded segment 238 adjacent to the annular flange 232 and a thread relief band 240 between the annular flange 232 and the threaded segment 238. See also, FIGS. 42-44. Another thread relief band 242 may abut the distal side of the threaded segment 238. Next, the rod 194 may include a hexagonal segment 244 next to the distal thread relief band 242. Further, the rod 194 may include an axle segment 246 between the hexagonal segment and the tip. A slot 248 transverse to the central axis may bisect the tip 230 and a distal portion of the axle segment 246.

The intermediate ring 196 may include a proximal side boss 250, a distal side boss 252, and an annular flange 254 therebetween. See also, FIGS. 42-44. A leading rectangular tab 256 may extend from the distal side of the annular flange. The leading rectangular tab may extend past the distal side boss. Similarly, a trailing rectangular tab 258 may extend from the proximal side of the annular flange. The trailing rectangular tab 258 may extend past the proximal side boss. Further, the intermediate ring may include a central opening 260 that extends from the distal side boss to the proximal side boss. The central opening may include a side wall 262. The side wall may include a screw thread 264. The screw thread 264 on the side wall 262 and the screw thread 266 on the threaded segment 238 of the rod may be mating screw threads.

The distal stop body 198 may include a cylindrical base 268 and a cylinder 270 extending from the cylindrical base. The lower surface 272 of the cylindrical base 268 may include a block 274. See also, FIGS. 42-44. A bore 276 may extend from the upper surface of the cylinder to the lower surface of the cylindrical base. The bore may include a central axis. The bore may have a cross-section perpendicular to the central axis. The cross-section may have hexagonal shape. The hexagonal shape of the cross- section may be configured and dimensioned to be slidably received on the hexagonal segment 244 of the rod and to mate therewith to prevent relevant movement between the rod 194 and the distal stop body 198. The cross-section further may include a rectangular slot 278. The rectangular slot 278 may be configured and dimensioned to slidably receive an indexing tab 280 on the hexagonal segment 244 of the rod. Accordingly, the distal stop body may be connected to the rod in a fixed orientation. For example, the distal stop body 198 may be connected to the rod 194 such that the block on the lower surface 272 of the cylindrical base is generally aligned with the rectangular block 236 on the annular flange of the rod.

The distal ring 200 may include a rim 282 and an annular flange 284. See also, FIGS. 42-44. The rim 282 may include an outer surface and an inner surface. The annular flange 284 may be disposed on the outer surface of the rim. The rim 282 further may include a central ring 286 and a plurality of spokes 288 extending from the central ring 286 to the inner surface of the rim. The central ring 286 may be configured and dimensioned to form a press fit connection with the tip 230 and axle segment 246 of the rod such that the distal ring 200 may rotate freely about the axle segment 246.

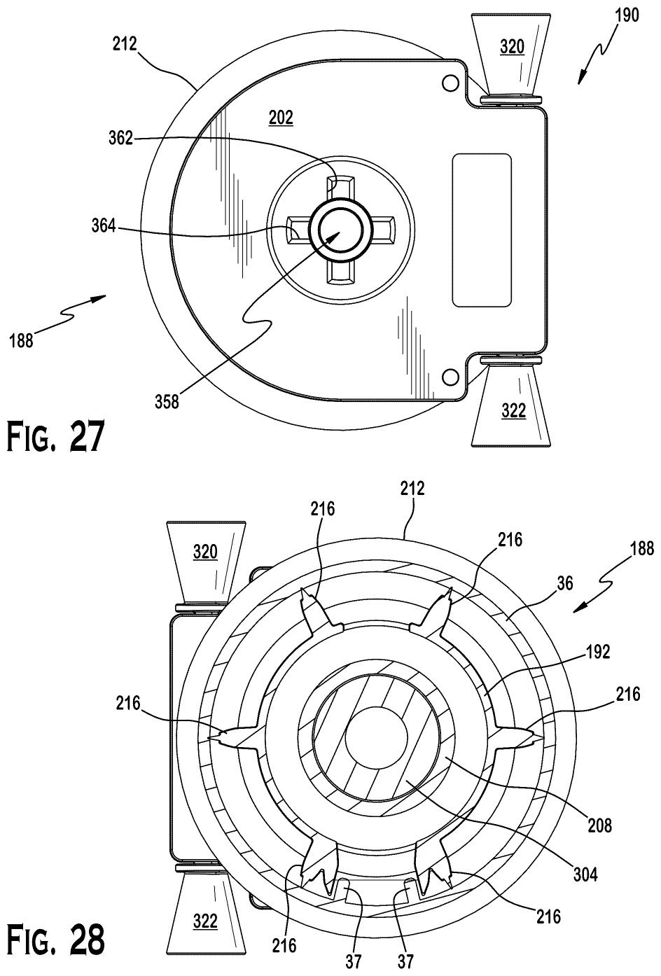

Additionally, the cylindrical member 214 of the idler body 192, the annular flange 254 of the intermediate ring 196, and the annular flange 284 of the distal ring 200 may each include a pair of opposing notches 290. Each pair of opposing notches 290 may be substantially the same. Additionally, each notch 290 may be configured and dimensioned to engage with two indexing rails 37 on the inside of the major tube 36. See also, FIGS. 28-37.

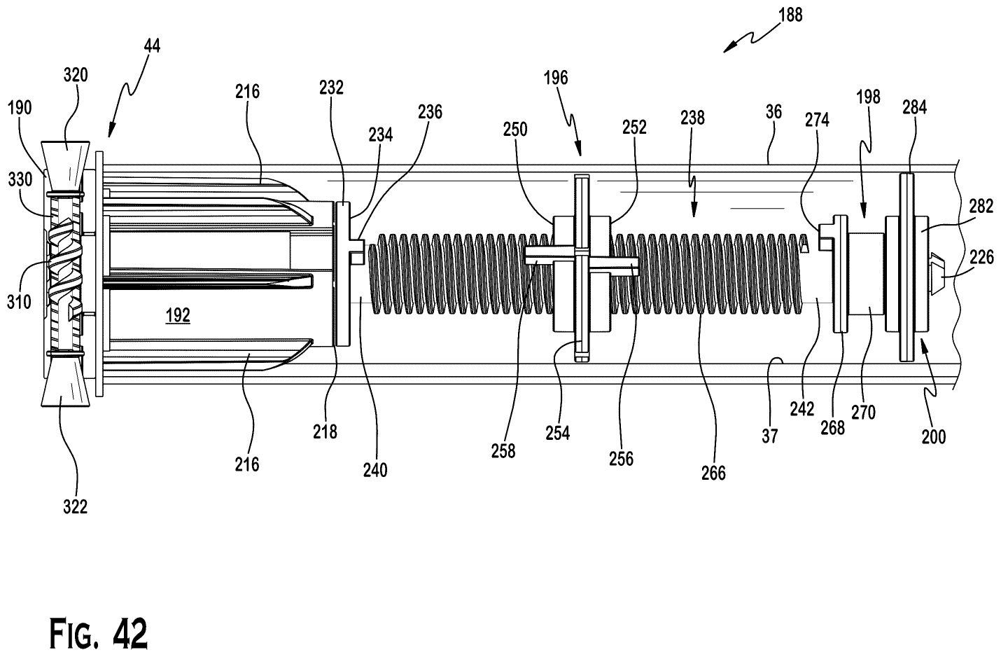

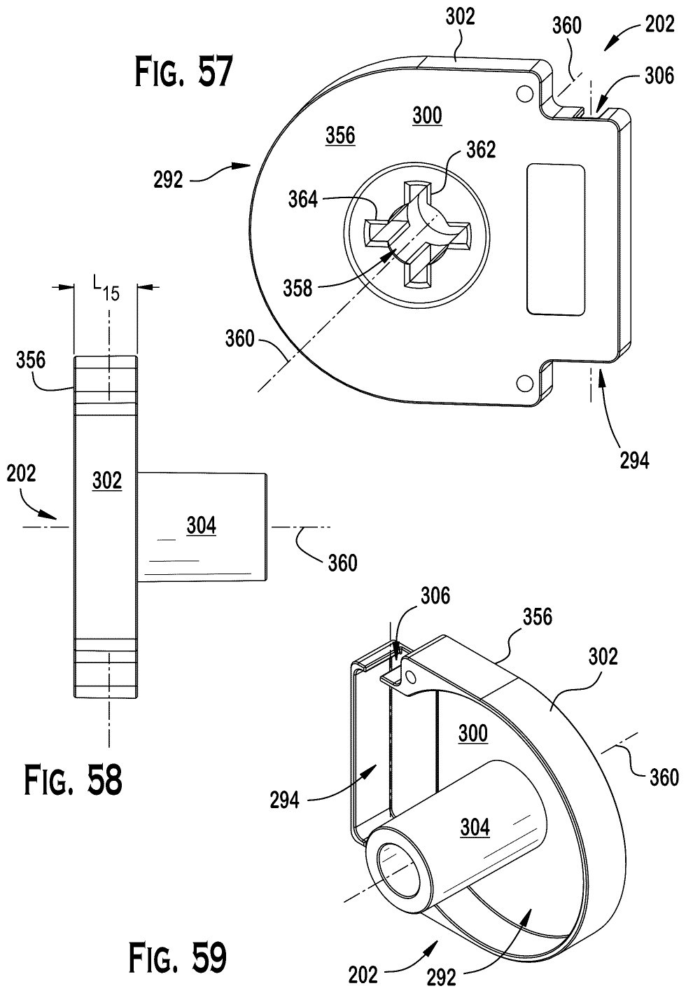

FIG. 45 is an exploded view of the adjustable stop worm drive housing 190. The adjustable stop worm drive housing 190 may include a proximal side enclosure 202 and distal side enclosure cover 204. Referring to FIGS. 46, 48, and 57-60, the proximal side enclosure 202 may include a proximal end wall 300, a peripheral side wall 302, a tubular shaft 304 which extends from the proximal end wall, and a pair of opposing cutouts 306 in the peripheral side wall. A rectangular shaped portion of the peripheral side wall, including the pair of opposing cutouts 306, may define a worm screw receptacle 294. A lobe shaped portion of the peripheral side wall, including the tubular shaft, may define a worm gear receptacle 292. The outer surface 356 of the proximal end wall 300 may include a blind hole 358 which may be centered about the central axis 360 of the tubular shaft 304 of the proximal side enclosure 202. Additionally, the blind hole 358 may be intersected by a first elongated slot 362 and a second elongated slot. The first elongated slot may be aligned parallel to the rotational axis of the worm screw. The second elongated slot 364 may be aligned perpendicular to the first elongated slot. The first elongated slot and the second elongated slot may be configured and dimensioned to receive a portion of the tube bracket 52.

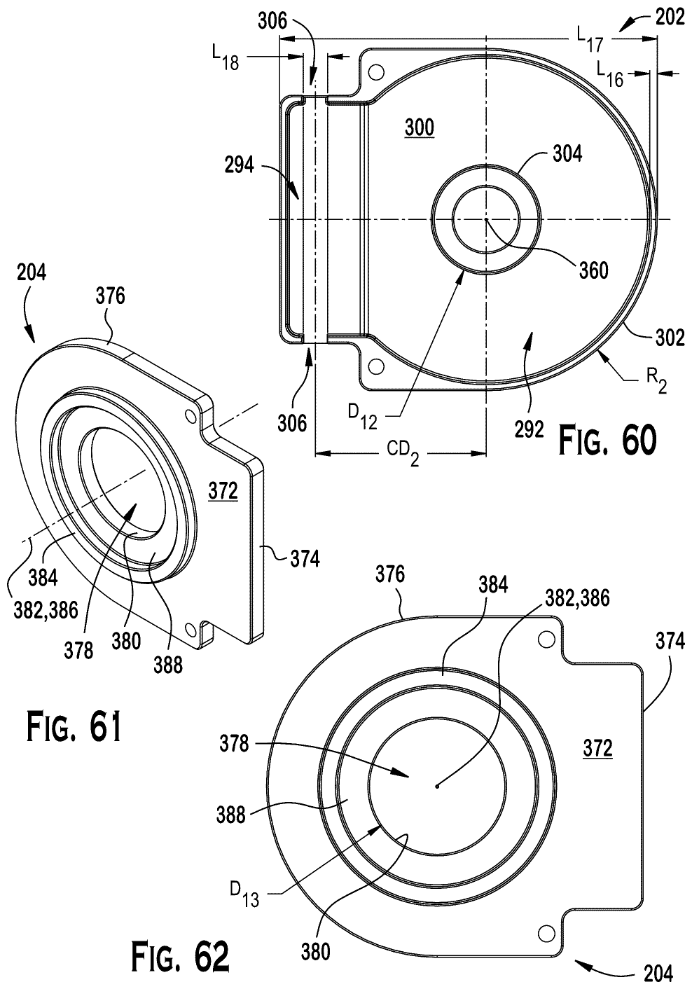

Referring to FIGS. 45, 61, and 62, the distal side enclosure cover 204 of the adjustable stop gear housing 190 may include an inner surface 372, an outer surface 374, and a circular opening 378 extending from the inner surface 372 to the outer surface 374. The circular opening may have a side wall 380 and a central axis 382. Additionally, the inner surface 372 may include an annular boss 382. The annular boss may have a central axis 386 which is coincident with the central axis 382 of the circular opening 378. Also, the annular boss 386 and circular opening may define an annular area on the inner surface of the distal side enclosure cover.

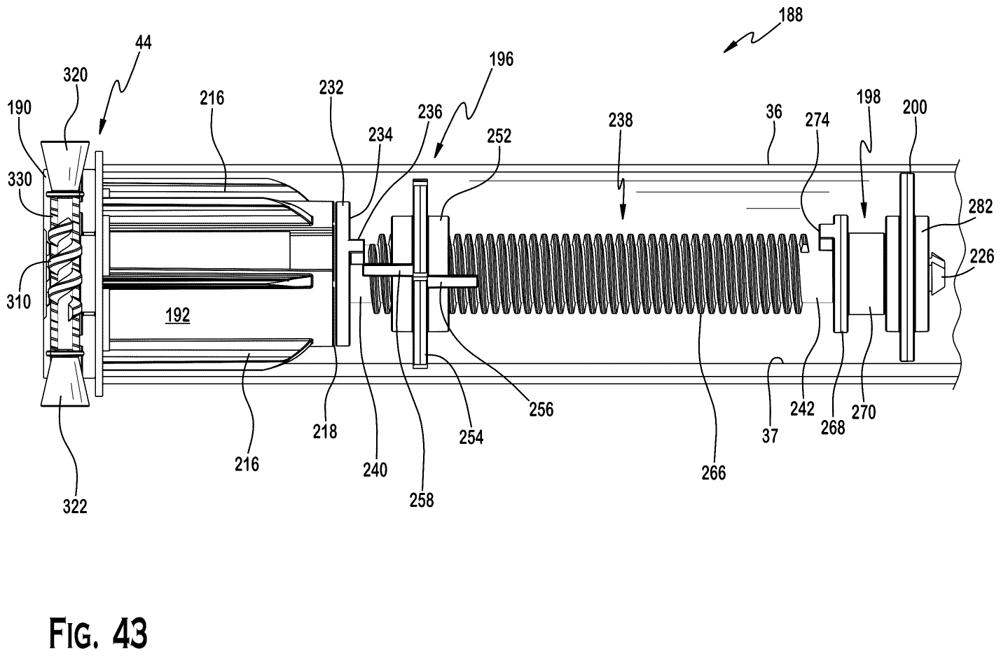

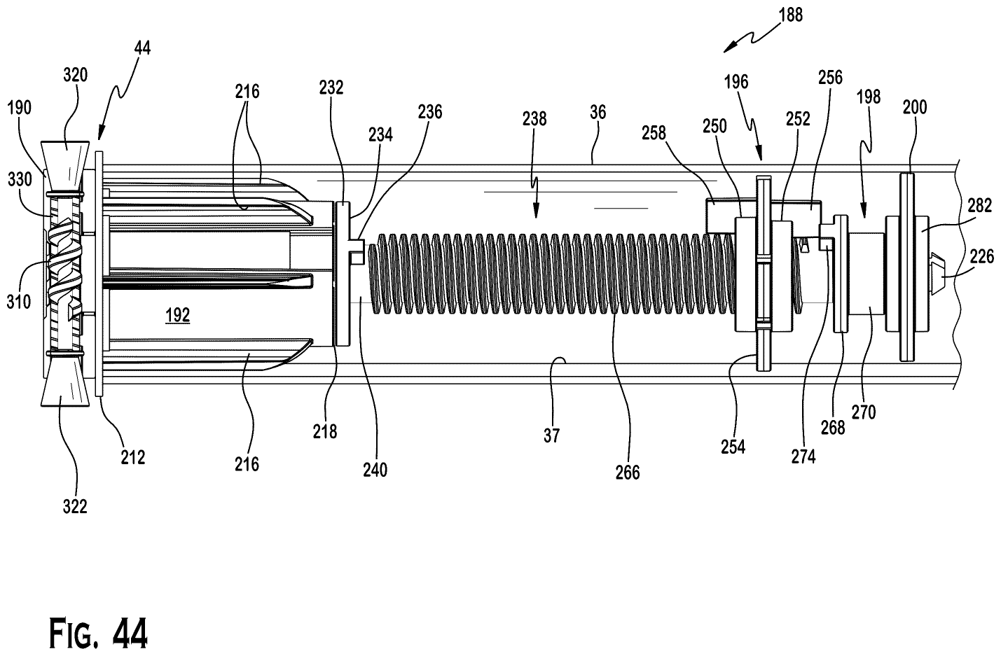

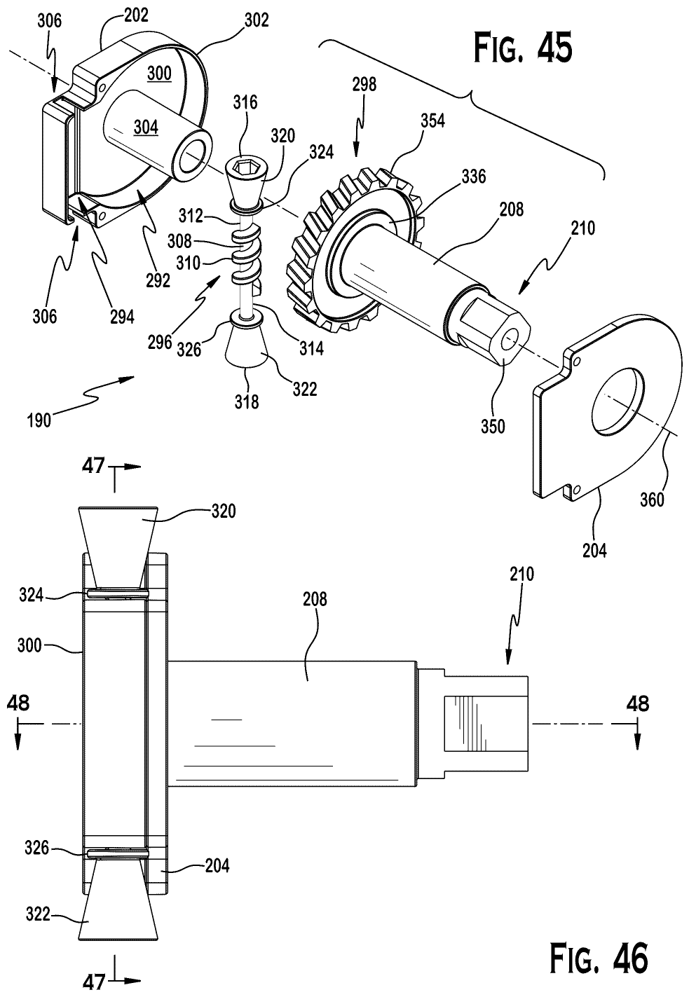

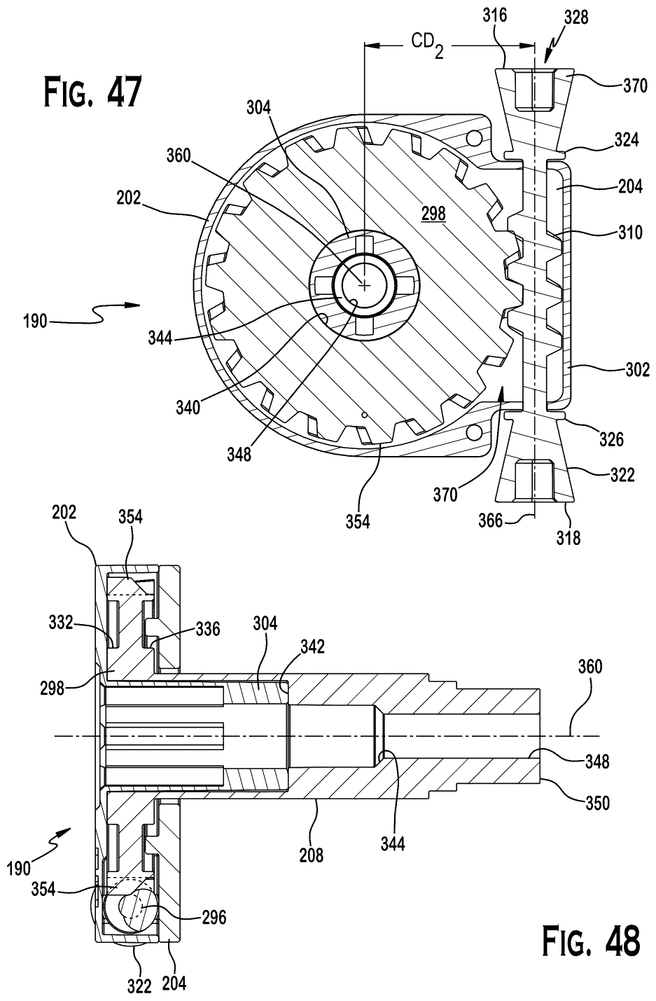

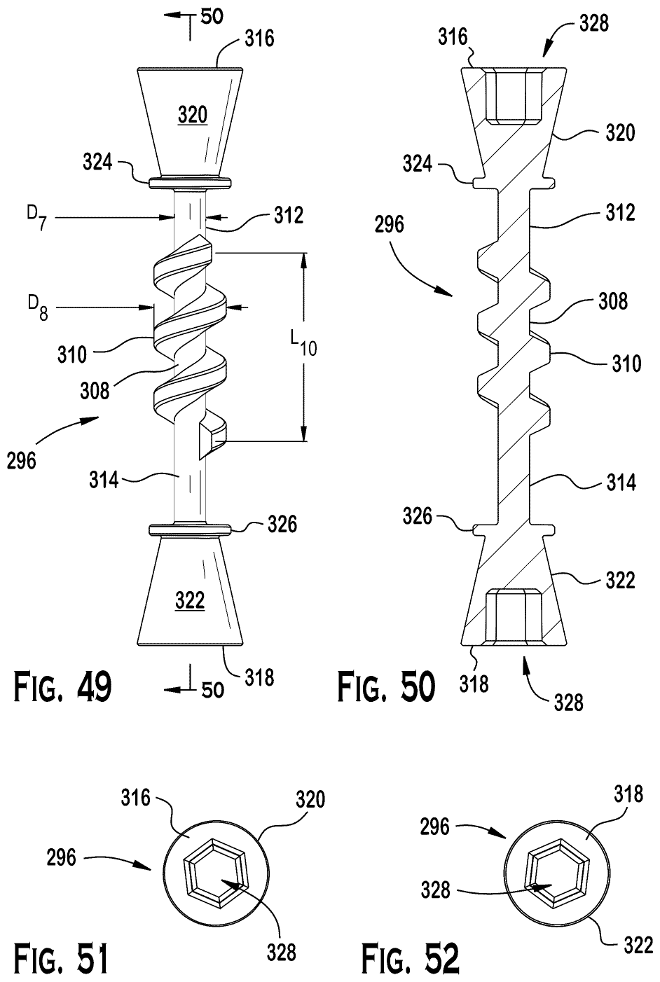

Referring to FIGS. 45, 49 and 50, the worm screw 296 may include a shaft 308, a screw thread 310, a first nonthreaded segment 312 located on the superior side of the screw thread 310, and a second nonthreaded segment 314 located on the inferior side of the screw thread. The shaft 308 further may include a superior end 316 and an inferior end 318. The superior end 316 may be the base of a superior frustoconical thumb knob 320 which may be turned by an operator to rotate the worm screw. Similarly, the inferior end 318 may be the base of an inferior frustoconical thumb knob 322 which also may be turned by an operator to rotate the worm screw. The worm screw 296 further may include a superior flange 324 disposed about the shaft 308 between the superior frustoconical thumb knob 320 and the first nonthreaded segment 312. Similarly, the worm screw 296 further may include an inferior flange 326 disposed on the shaft 308 between the inferior frustoconical thumb knob 322 and the second nonthreaded segment 314. Referring to FIGS. 51-52, the superior end 316 and the inferior end 318 of the worm screw may include a tool fitting 328. Although an M4 hexagonal recess may be a preferred tool fitting, other tool fittings may be used provided that a mating tool may be used by an operator to selectively rotate the worm screw. For example, without limitation, a slot, a Philips head, a star, a square, or a hex-bolt tool fitting may be used. In a preferred embodiment, the worm screw may have three threads. More particularly, the worm screw may have a pitch of 0.075 inches for 40 revolutions in the preferred embodiment. Referring to FIGS. 47-52, exemplary dimensions for the worm screw are presented in Table 3.

TABLE 3
Illustrative IAS Device Worm Screw and Worm Gear Dimensions

| Dimen- | | Length | |
|---|---|---|---|
| sion | Description | (inches) | FIG. |
| L10 | Worm screw (296), length | 0.6 | 49 |
| L11 | Pitch (tooth face-to-tooth face), length | 0.115 | 54 |
| L12 | Tooth depth (top of tooth-to-root), length | 0.065 | 54 |
| L13 | Length of shaft (208), length | 1.167 | 55 |
| L14 | Width of worm gear (330) | 0.2 | 55 |
| CD2 | Center distance of worm drive, length | 0.723 | 47 |
| D7 | Diameter of screw shaft (308, 312, 314), length | 0.135 | 49 |
| D8 | Diameter of worm screw (310), length | 0.23 | 49 |
| D9 | Diameter of first circular bore (340), length | 0.742 | 54 |
| D10 | Diameter of transmission shaft (208), length | 0.532 | 56 |
| D11 | Diameter of worm gear (330) | 1.35 | 56 |

Notes:
(a) Illustrative values for length and diameter dimensions are presented to the least significant digit without rounding but within standard manufacturing tolerances.

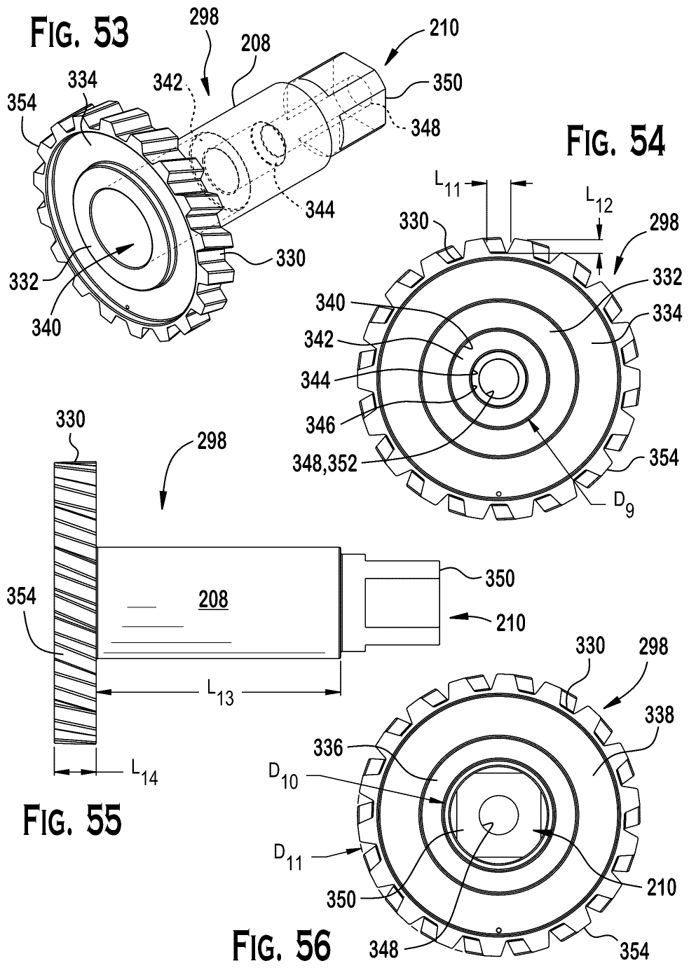

Referring to FIGS. 45 and 53-56, the worm gear 298 may include a helical gear 330, an outer boss 332 on the front side 334 of the helical gear, an inner boss 336 on the rear side 338 of the helical gear, a drive shaft 208 extending from the inner boss, and a square shaped power-take-off (PTO) fitting on the distal end of the drive shaft. The helical gear and the drive shaft may have a central axis. A first circular bore may extend from the outer boss to a first interior endwall. A second circular bore may extend from the first interior endwall to the base of an interior frustoconical surface. And, a third circular bore may extend from the distal end of the drive shaft to top of the interior frustoconical surface. The first circular bore, the second circular bore, and the third circular bore may be aligned with the central axis. In a preferred embodiment, the helical gear may have 18 teeth. More particularly, the helical gear may have a pitch of 10 inches for 0.02 revolutions. The helix angle may be about 20.6 degrees. Referring to FIGS. 47 and 53-56, exemplary dimensions for the worm gear are presented in Table 3 (above).

Referring to FIG. 45 and FIG. 47, the worm screw 296 may be arranged in the worm screw receptacle 292 such that the first and second unthreaded segments 312, 314 may be disposed in the respective cutouts 306 of the peripheral wall 202. Additionally, the superior flange 324 and the inferior flange 326 may each abut the peripheral side wall 302. Within the worm screw receptacle 292, the worm screw may have a rotational axis 366. Moreover, the worm gear 298 may be seated on the tubular shaft 304 of the proximal side enclosure 300. The worm gear 298 may turn about the tubular shaft 304. Hence, the worm gear 298 may have rotational axis 368 coincident with the central axis 360 of the tubular shaft. In a preferred embodiment, the center distance CD2 of the worm drive 370 may be about 0.723 inches. Referring to FIGS. 47 and 57-62, exemplary dimensions for the worm gear receptacle are presented in Table 4.

TABLE 4
Illustrative IAS Device Gear Housing Dimensions

| | | Length | |
|---|---|---|---|
| Dimension | Description | (inches) | FIG. |
| L15 | Thickness of proximal side enclosure | 0.27 | 58 |
| | (302), length | | |
| L16 | Thickness of peripheral side wall | 0.032 | 60 |
| | (302), length | | |
| L17 | Width proximal side enclosure (302), length | 1.605 | 60 |
| L18 | Width of rectangular cutout (306), length | 0.104 | 60 |
| CD2 | Center distance of worm drive, length | 0.723 | 60 |
| R2 | Radius of helical gear receptacle, length | 0.727 | 60 |
| D12 | Diameter of tubular shaft (304), length | 0.468 | 60 |
| D13 | Diameter of circular opening (380) | 0.575 | 62 |
| | on distal side enclosure, length | | |

Notes:
(a) Illustrative values for length and diameter dimensions are presented to the least significant digit without rounding but within standard manufacturing tolerances.

Referring to FIGS. 26 and 42-44, the ASA 188 may include an IAS device 44, as well as a roller tube (or major tube) 36 for receiving a screen of fabric material for a window shade. The opposite end of the major tube may include a clutch 42 or a tube motor (not shown). The IAS device 44 and the clutch 42 or tube motor (not shown) may be fixedly secured within the cassette 12 that is attached to a window frame. Generally, the IAS device further may disposed in one side of the major tube 36. More particularly, the idler body 192 may be inserted into one end of the major tube 36, but the IAS worm drive housing 190 may be disposed adjacent to the major tube 36. Also, the circular base 212 of the idler body 192 may be disposed between the IAS worm drive housing 190 and the major tube 36.

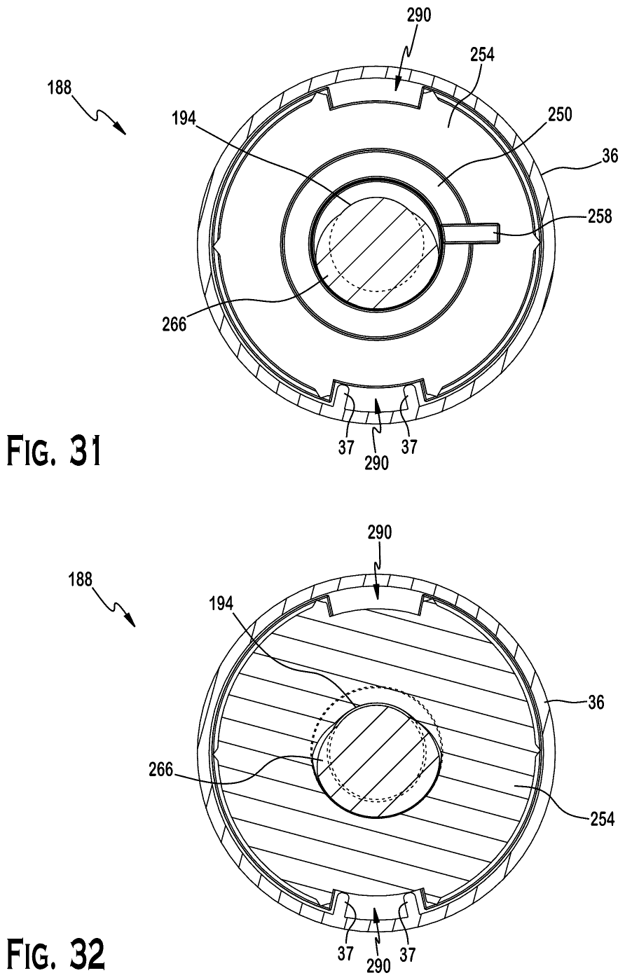

Referring to FIGS. 26, 37 and 40, the worm drive 110 may rotate the rod 194 independently of the major tube 36 and the idler body 192. Referring to FIGS. 26 and 42, the intermediate ring 196 may be arranged approximately midway along the threaded segment 238 of the rod 194. A transmission notch 290 on the annular flange 254 of the intermediate ring 196 may engage with a pair of indexing rails 37 of the major tube. See also, FIGS. 31-33. Moreover, the indexing rails 37 may engage with a transmission notch 290 on the cylindrical member 214 of the idler body 192, as well as with a transmission notch 290 on the distal ring 200. The idler body 192, however, may rotate freely about the axle 206 of the IAS worm drive housing 190. Similarly, the distal ring may rotate freely about the axle segment 246 of the rod.

Referring to FIG. 42, as the clutch 42 or tube motor (not shown) rotate the major tube 36, the indexing rails 37 may rotate the idler body 192 about the axle 206 of the IAS worm drive housing 190. Similarly, the indexing rails 37 may rotate the distal ring about the axle segment of the rod. Further still, the pair of indexing rails may turn the intermediate ring about the threaded segment of the rod which remains fixed to the worm drive transmission shaft 208. Relative rotation of the intermediate ring 196 and the threaded segment of the rod may advance the intermediate ring along the threaded segment of the rod in one direction. Similarly, relative rotation of the intermediate ring 196 and the threaded segment of the rod in the opposite direction may advance the intermediate ring along the threaded segment of the rod in opposite direction.

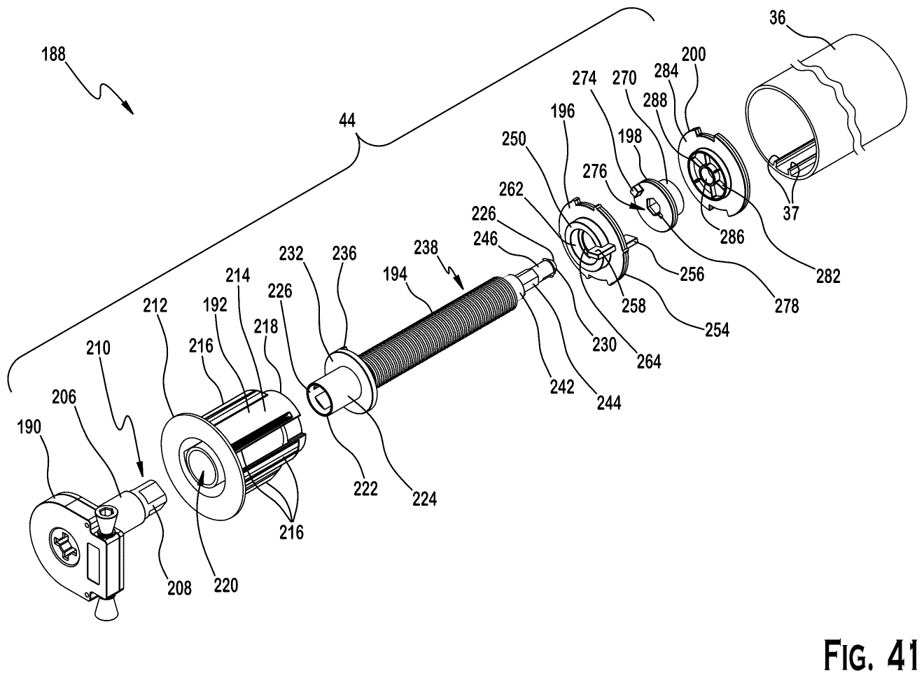

As shown in FIG. 43, relative rotation of the intermediate ring 196 about the threaded segment of the rod in one direction may advance the intermediate ring along the threaded segment until the trailing rectangular tab 258 on the intermediate ring encounters the rectangular block 236 on the annular flange of rod. The rectangular block stops the trailing rectangular tab from rotating by blocking its path of travel. Because, the intermediate ring is engaged with the indexing rails of the major tube, this stops the major tube from rotating further in that direction. Similarly, referring to FIG. 44, relative rotation of the intermediate ring 196 about the threaded segment of the rod in opposite direction may advance the intermediate ring along the threaded segment in the opposite direction until the leading rectangular tab 256 on the intermediate ring encounters the rectangular block 274 on the lower surface of the distal stop body 198. The distal stop body 198 being positively engaged to the hexagonal segment 244 and indexing tab 280 on the rod stops the leading rectangular tab 256 from rotating by blocking its path of travel. Again, because the intermediate ring is engaged with the indexing rails of the major tube, this stops the major tube from rotating further in that direction.

Accordingly, as the window shade 16 is lowered the major tube 36 rotates to unspool fabric material causing the intermediate ring 196 to translate toward one end of the shaft until the leading rectangular tab 256 or the trailing rectangular tab 258 engages the rectangular block 274 on the lower surface of the distal stop body 198 or the rectangular block 236 on the annular flange, respectively. The amount of fabric that may unspool from the major tube may be regulated by setting the initial position of the intermediate ring on the threaded segment of the rod. This may be accomplished by turning the worm shaft 116 which rotates the worm gear 112 that turns the worm drive transmission shaft 208 and rod 194 with respect to the major tube 36.

More specifically, as the rod is rotated with respect to the major tube, the intermediate ring is rotated about the threaded segment of the rod. Thus, turning the worm shaft in one direction moves the intermediate ring along the threaded shaft in one direction; whereas turning the worm shaft in the opposite direction moves the intermediate ring along the threaded segment of the shaft in the opposite direction. Therefore, the amount of fabric that may unspool from the major tube may be regulated by using the worm drive to set an initial position of the intermediate ring on the threaded segment of the rod. In use, the adjustable stop apparatus for the window shade may be calibrated to stop rotation of the major tube when the full working length of the fabric material shade is deployed to cover an opening or window. This may be accomplished by lowering the window shade to the desired working length, and then turning the worm until the intermediate ring abuts the rectangular stop in the appropriate translational direction to block further rotation of the major tube and the associated unspooling of window shade fabric.

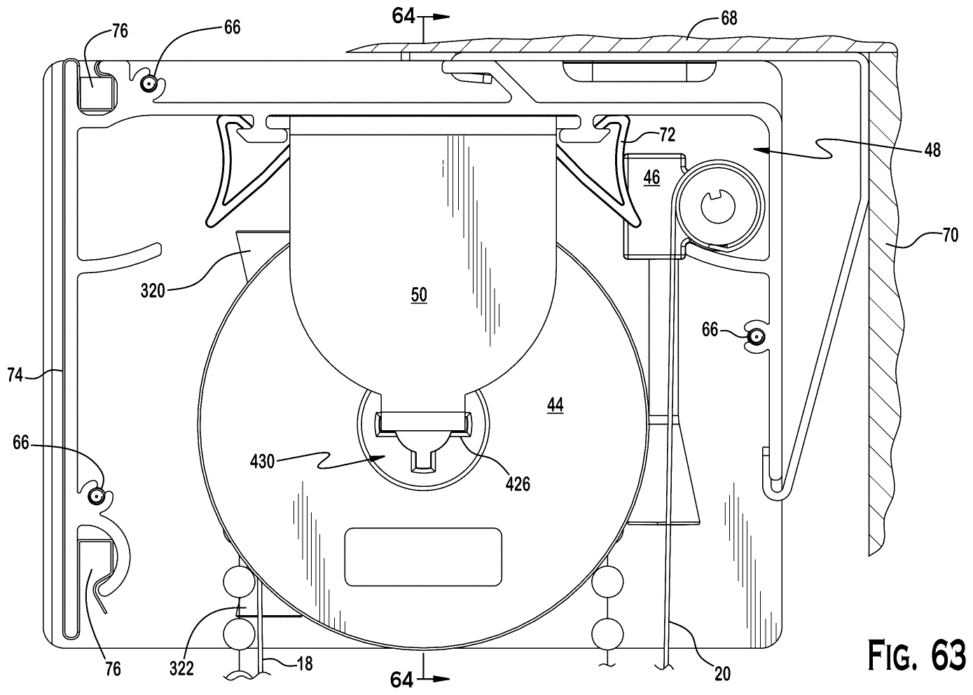

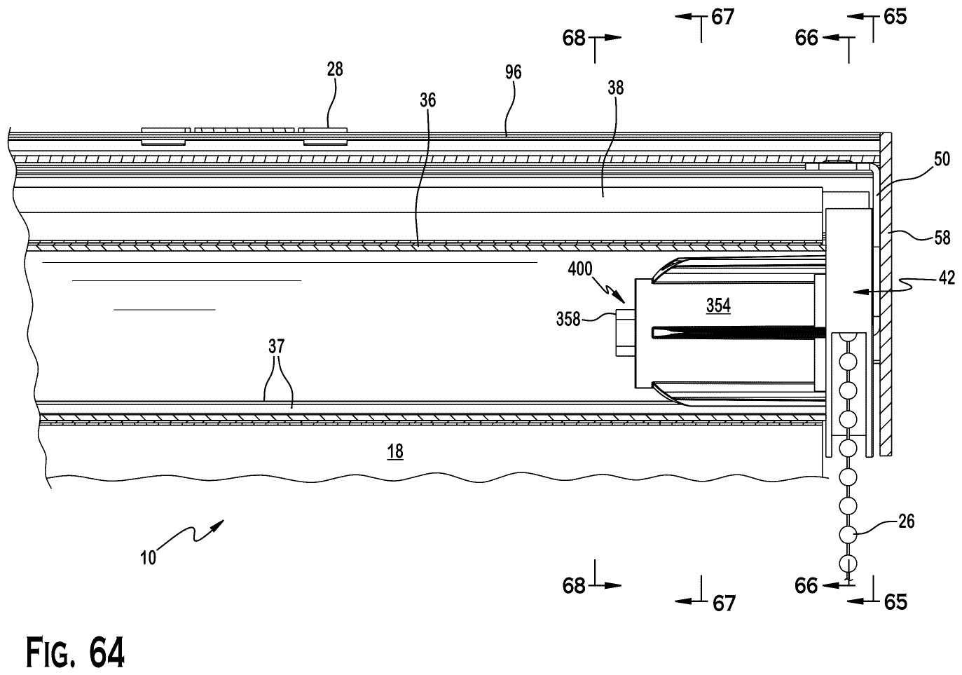

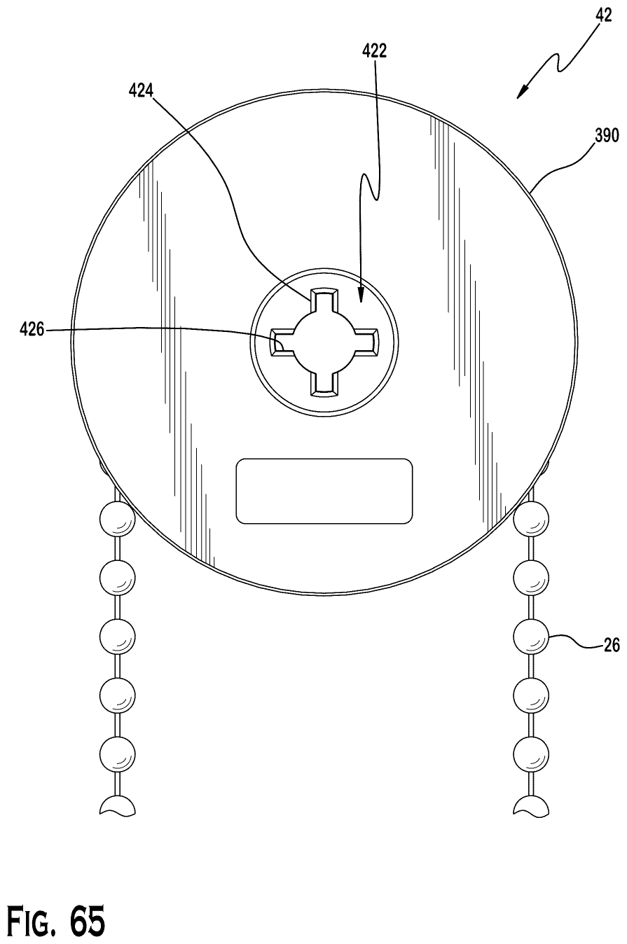

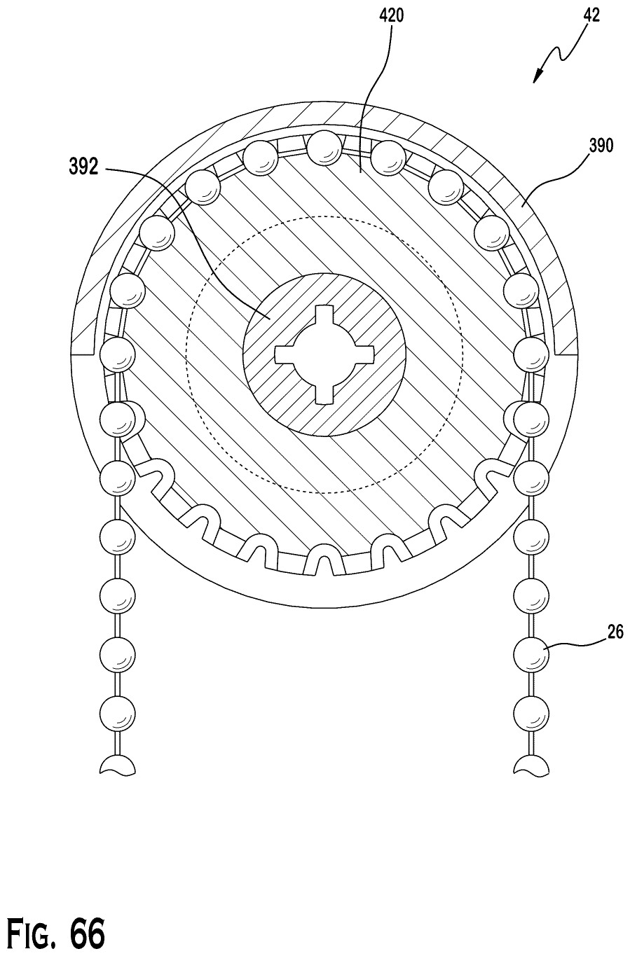

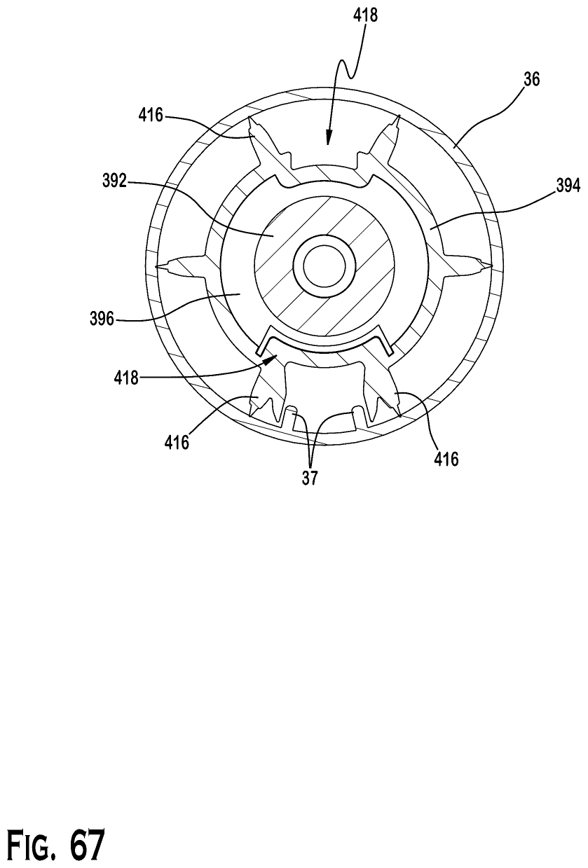

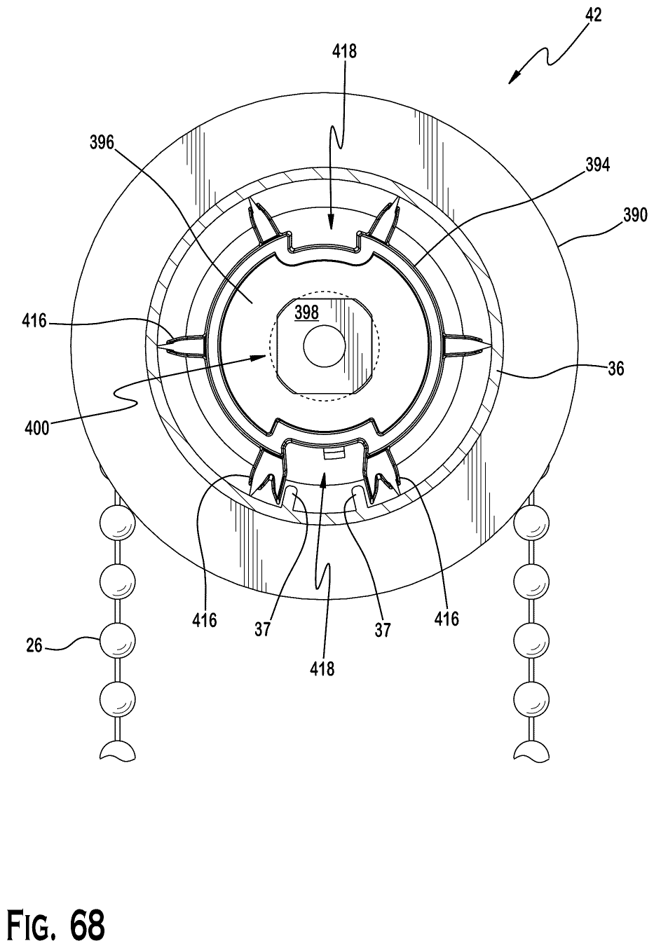

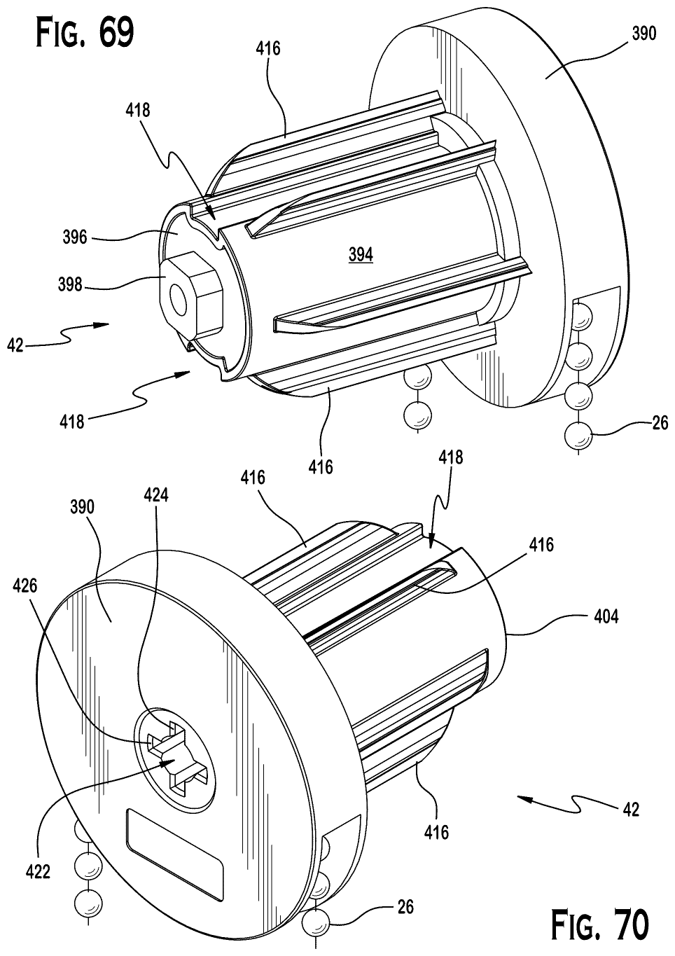

Referring to FIG. 4 and FIG. 64, the major tube 36 may be fitted with a clutch 42 and drive chain 26 to selectively rotate the major tube 36 and raise or lower the shade 16. Although, a clutch 42 may be used by an operator to selectively rotate the major tube 36, a tube motor may be used instead of the clutch. Referring to FIG. 69 and FIG. 70, the clutch 42 may include a gear housing 390 and drive shaft 392, a clutch body 394 for interfacing with the major tube, and a keyed fitting 396 that connects the clutch body 394 to the distal end 398 of the drive shaft. The distal end 398 of the drive shaft may include a power take off (PTO) fitting 400. The clutch body 394 may include a proximal end 402, a distal end 404, and a passage 406 extending from proximal end 402 to the distal end 404. The passage 406 may have a circular cylindrical portion 408 adjacent to the proximal end 402 and a shaped receptacle portion 410 disposed between the circular cylindrical portion 408 and the distal end 404. The circular cylindrical portion 408 of the passage 406 may be configured and dimensioned to telescopically receive the PTO fitting 400 of the drive shaft 392. The shaped receptacle portion 410 of the passage may be configured and dimensioned to interlock with the keyed fitting 396. Additionally, referring to FIG. 70 and FIG. 71, the keyed fitting 396 may include a central bore 412 that is configured and dimensioned to telescopically receive the PTO fitting 400 of the drive shaft 392. Moreover, as shown in FIG. 69 and FIG. 71, the outer surface 414 of the clutch body 394 may include a plurality of radial fins 416, as well as two longitudinal recesses 418. As shown in FIGS. 64, 67, and 68, the longitudinal recesses 418 may be configured and dimensioned to interlock with a pair of indexing rails 37 on the inner surface of the major tube 36. Referring to FIG. 66, the gear housing 390 may include a drive gear 420. The drive gear 420 may be integrally formed with the drive shaft 392. The drive chain 26 may be engaged with the drive gear 420 such that moving the chain 26 downward on one side of the gear housing 390 rotates the drive gear 420 and drive shaft 392 in one direction and moving the chain 26 downward on the other side of the gear housing 390 rotates the drive gear 420 and drive shaft 392 in the reverse direction. Referring to FIG. 65 and FIG. 70, the clutch 42 further may include a blind hole 422. The blind hole 422 may be intersected by a first elongated slot 424 and a second elongated slot 426. The second elongated slot 426 may be perpendicular to the first elongated slot 424. The blind hole 422, the first elongated slot 424, and the second elongated slot 426 may be centered about the rotational axis 428 of the drive shaft 392. As shown, in FIG. 63, the blind hole 422, first elongated slot 424, and the second elongated slot 426 may be configured and dimensioned to form a mounting receptacle 430 for receiving a portion of the tube bracket 52.

Referring to FIG. 4 and FIG. 72, the window shade apparatus 10 may include a bottom bar 14. As shown in FIGS. 74 and 75, the bottom bar 14 may include a cover track 432, a tubular rod 434, a bearing insert 436, an end cap 438, and a pair of fastening screws 440.

As shown in FIG. 72, the bottom bar 14 may have a cross-section perpendicular to the longitudinal axis of the bottom bar. For instance, the cover track 432 may have a generally rectangular exterior profile but with a slot 442 on top and internal features that preferably incorporate rounded shapes and edges. More particularly, the cross-section of the cover track 432 may include a bottom wall 444, a front wall 446, a rear wall 448, a rear ledge 450, and a front ledge 452. The cross- section of the cover track further may include a front arcuate shelf 454 projecting from the front wall 446 toward the slot 442, and a rear arcuate shelf 456 projecting from the rear wall 448 toward the slot 442. The front arcuate shelf 454 and the front ledge 452 may define a rounded front cavity 458 with a constricted opening 460 facing the slot. Similarly, the rear arcuate shelf 456 and the rear ledge 450 may define a rounded rear cavity 462 with a constricted opening 464 facing the slot. Additionally, the cross-section of the cover track 432 may include a front c-shaped projection 466 disposed below the front arcuate shelf 454, as well as a rear c-shaped projection 468 disposed below the rear arcuate shelf 456. The opening of the front c-shaped projection facing the lower rear corner formed by the intersection of the rear wall 448 and the bottom wall 444, and the opening of the rear c-shaped projection facing the lower front corner formed by the intersection of the front wall 446 and the bottom wall 444. In the preferred embodiment, the outer dimensions of the cover track are approximately 0.912 inches and approximately 1.435 inches. Preferably, the cover track may be a powder coated aluminum extrusion.

Referring to FIGS. 4, 72 and 74, the tubular rod 434 may have a central axis 470 and include a port side end and a starboard side end spaced from the port side end along the central axis. The tubular rod 434 further may include a bore 472. The bore 472 may extend from the port side end to the starboard side end. The tubular rod may have a cross section perpendicular to the central axis, the cross-section including a circular outer profile and a central bore. The bore 472 may have noncircular shape. The tubular rod 434 may have a constant outer diameter. In a preferred embodiment, the outer diameter of the tubular rod is approximately 0.595 inches. The distance between the rear wall 448 and the front wall 446 of the cover track may be approximately 0.802 inches. The ratio of the distance between the rear wall 448 and the front wall 446 divided by the outer diameter of the tubular rod 432 may be about 1.35. Preferably, the distance between the tubular rod and the front wall or real wall may be about 0.1035 inches and the distance between the tubular and the bottom wall may be about 0.085 inches.

Referring to FIGS. 73-75, the bearing insert 436 may include a tube 474 with an annular flange 476. The outer diameter of the annular flange may be approximately the same as the outer diameter of the tubular rod. The outer profile of the tube may be configured and dimensioned to be telescopically received in the bore 472 of the tubular rod. Additionally, the tube 474 may have a central axis and a circular passage 478 extending through the tube about the central axis. The inner diameter of the tube may be configured and dimensioned to hold the circular cylindrical shaft 480 of the endcap (below) such that the tubular rod 434 and bearing insert 474 combination may rotate freely about the circular cylindrical shaft 480.

Referring to FIGS. 4 and 73-75, the bottom bar 14 may include an end cap 438 on each side of the cover track 432. The end cap 438 may include a rectangular end wall 482 and four perimeter side walls 484. The four perimeter sidewalls 484 may be configured and dimensioned to slidable receive one end of the cover track 432. Additionally, the end cap 438 may include two faster receiving holes 486. The fastener receiving holes 486 may be configured and dimensioned to fully receive the respective fasteners 488. For example, the fasteners 488 may be a screw with a countersunk head and the fastener receiving holes may correspond to the shape of the screw. The fastener receiving holes 486 may be arranged on the rectangular end wall 482 such that the fastener receiving holes 486 are aligned with the front and rear c-shaped projections 466, 468 on the cover track 432 when the cover track is fit into the end cap 438. Moreover, the end cap 438 may include a circular cylindrical shaft 480 that extends from the inner surface of the rectangular end wall 482. The circular cylindrical shaft 480 may be positioned to hold the tubular rod 434 in spaced relation to the front wall 446, rear wall 448, and bottom wall 444 of the cover track. The top perimeter side wall 484 may include a cutout 490.

Referring to FIGS. 80-84, the major tube 36 may form a primary spool for the shade 16, the minor tube 38 may form a secondary spool for the shade 16, and the tubular rod 434 in the bottom bar 14 may form a roller for the shade 16 such that the shade 16 is arranged with a proximal sheet 18 of flexible material (e.g., fabric material) between the major tube 36 and the tubular rod 434 and a distal sheet 20 of flexible material (e.g., fabric material) between the tubular rod 434 and the minor tube 38.

Referring to FIGS. 76 and 80, the modular window shade apparatus 10 may be installed in a window frame 15 in a normal roll configuration such that the shade 16 is between the window 17 and the major tube 36, the idler and adjustable stop device 44 and differential adjustment device 46 being arranged on the port side of the cassette 12.

Referring to FIGS. 77 and 81, the modular window shade apparatus 10 may be installed in a window frame 15 in a reverse roll configuration such that the major tube 36 is between the window 17 and the shade 16, the idler and adjustable stop device 44 and differential adjustment device 46 being arranged on the port side of the cassette 12.

Referring to FIGS. 78 and 82, the modular window shade apparatus 10 may be installed in a window frame 15 in a normal roll configuration such that the shade 16 is between the window 17 and the major tube 36, the idler and adjustable stop device 44 and differential adjustment device 46 being arranged on the starboard side of the cassette 12.

Referring to FIGS. 79 and 83, the modular window shade apparatus 10 may be installed in a window frame 15 in a reverse roll configuration such that the major tube 36 is between the window 17 and the shade 16, the idler and adjustable stop device 44 and differential adjustment device 46 being arranged on the starboard side of the cassette 12.

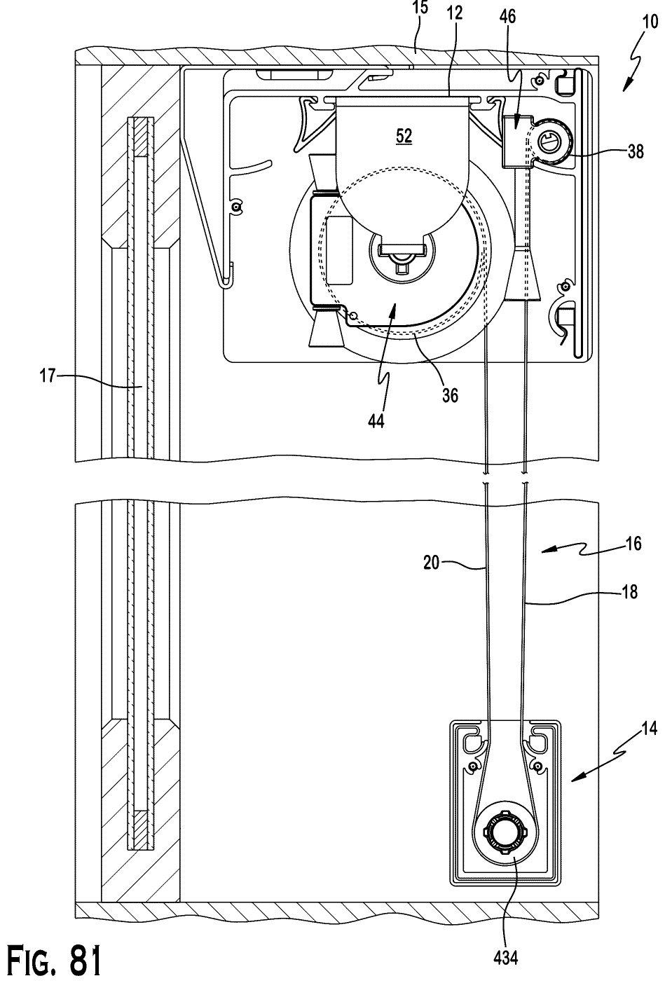

Referring to FIGS. 5, 7, 84 and 85, a flexible material (e.g., fabric material) 75 may be wrapped about the front wall 78 of the cassette 12. For instance, a sheet of fabric material 75 may be laid over the inferior hook 99 that is disposed on the inner surface of the front wall 78 of the cassette 12. The sheet of fabric material 75 may be pressed into the inferior concavity 100 using a hand tool (e.g., a tamp, a roller device, or a keyed slide) 500. An elastomeric spline 502 may be pressed into the inferior cavity 100 over the fabric material 75. The elastomeric spline 502 may expand into the inferior concavity 100 to hold the fabric material 75. The fabric material 75 then may be tightly wrapped around the front wall 78 of the cassette 12 and laid over the superior hook 97 that is disposed on the upper surface of the top wall 80 of the cassette. Preferably, the fabric material 75 may be mechanically clamped or taped to the upper surface of the top wall 80 to maintain tension in the sheet of fabric material 75 which is wrapped about the front wall 78 of the cassette 12. A fold of fabric material 75 may be pressed or tamped into the superior concavity 98 using the hand tool 502. Referring to FIG. 84 and FIG. 85, an elastomeric spline 502 may be pressed into the superior concavity 98 over the fabric material 75 using a suitable hand tool (e.g., a tamp or roller device) 500 to secure the sheet of flexible material 75 to the cassette 12. The sheet of fabric material 75 and the elastomeric spline 502 may be trimmed to provide a neat finish for the fabric valance 74 of the cassette.

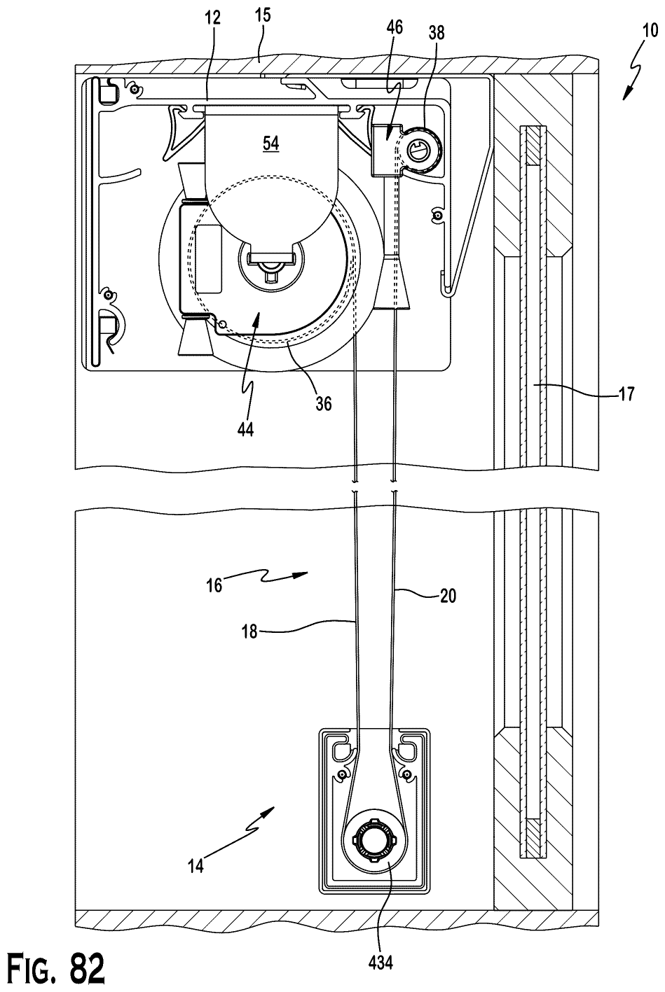

Referring to FIG. 86 and FIG. 87, a similar flexible material treatment may be applied to the cover track 432 of the bottom bar 14. More particularly, one end of a sheet of flexible material 75 may be secured in the rounded rear cavity 462 by an elastomeric spline 502 and the other end of the sheet of flexible material 75 may be secured in the rounded front cavity 458 by an elastomeric spline 502. The flexible material treatment applied to the cover track 432 of the bottom bar may securely wrap the sheet of flexible material 75 around the rear top ledge 450, the rear wall 448, the bottom wall 444, the front wall 446 and the front top ledge 452 of the cover track 432.

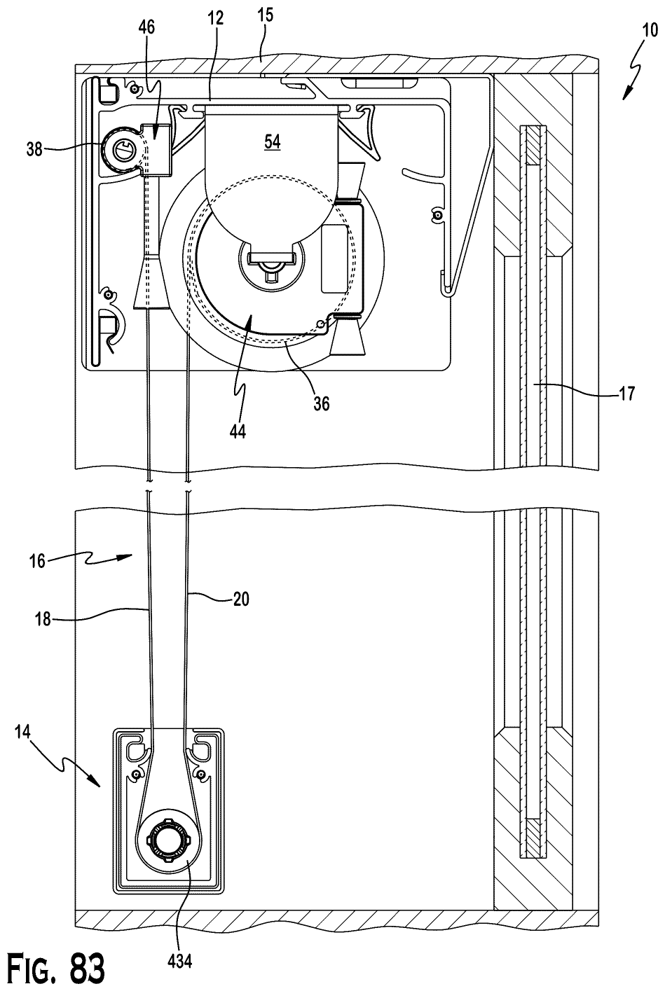

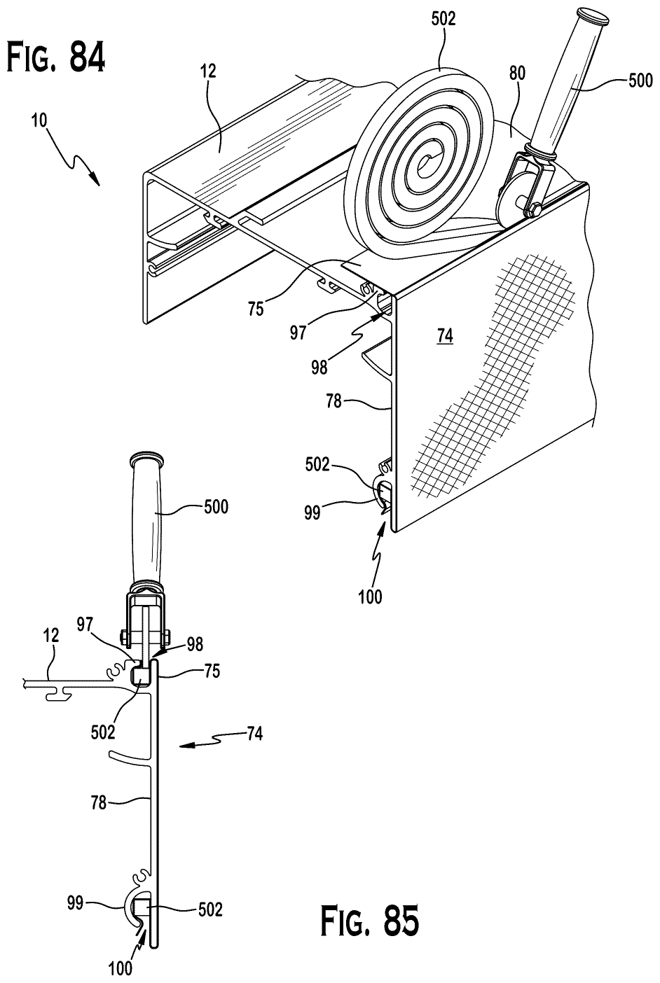

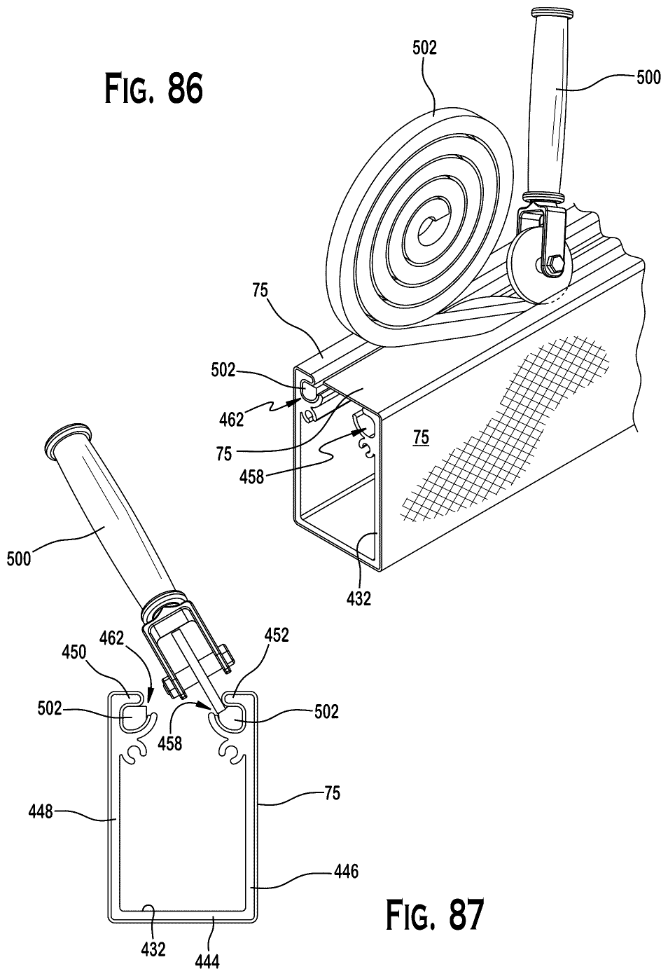

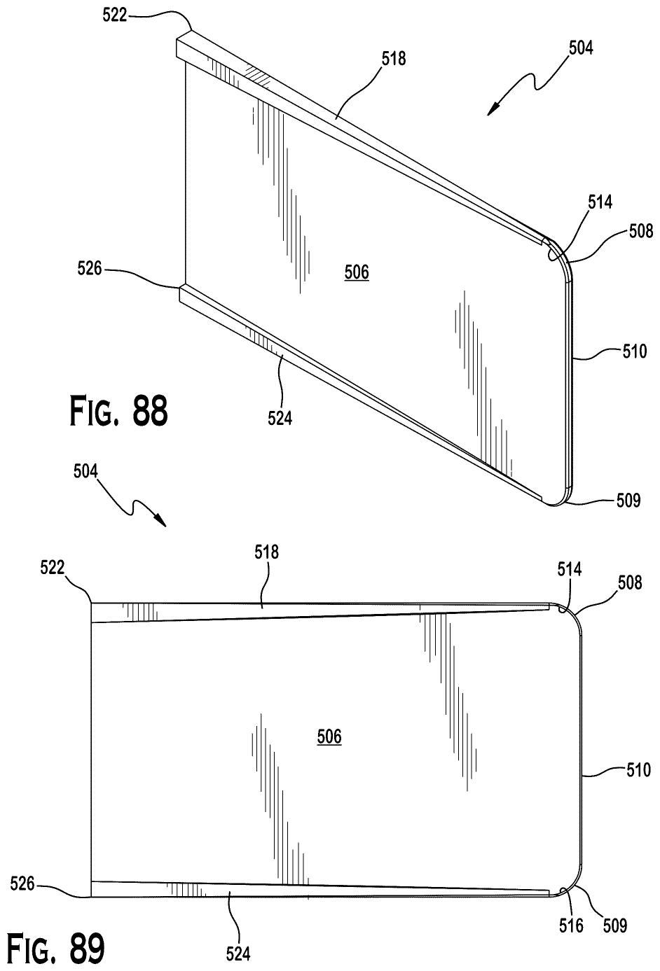

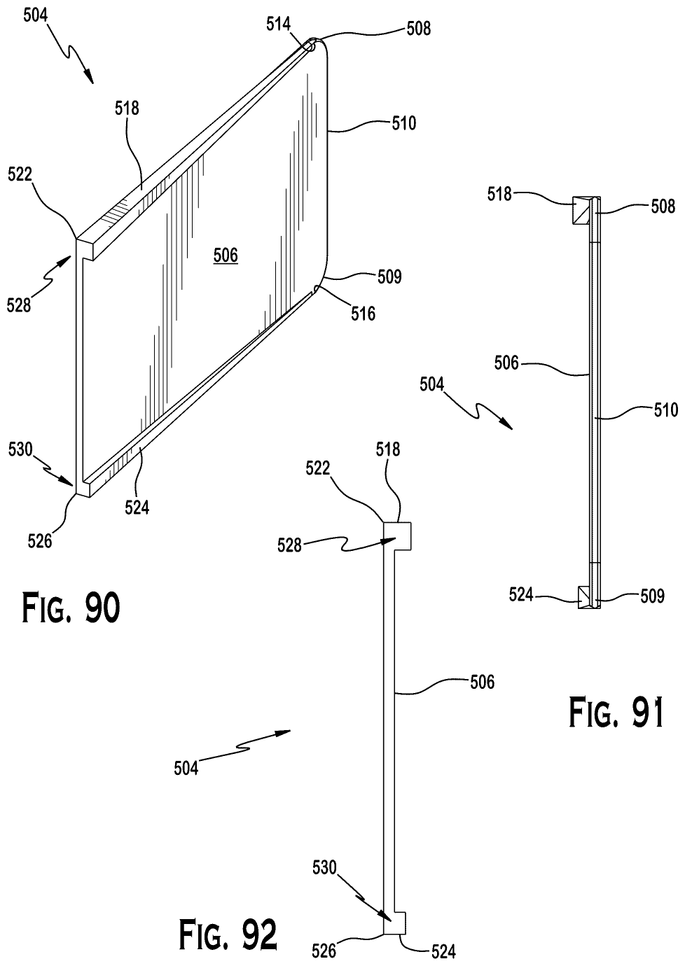

Referring to FIGS. 88-92, an exemplary embodiment of a hand tool 504 for use in applying a flexible material wrap to a cassette, a cover track, or other suitable profile is disclosed. The hand tool 504 may include a generally rigid rectangular card 506 having rounded corners 508, 509 on one side. The card may have uniform thickness. The edge 510 of the card on the one side, as well as the abutting curved segments also may be rounded. The card 506 further may include a first raised edge 518. The first raised edge 518 may be straight and may extend from a first square corner 522 to a first curved segment 514 of a first rounded corner 508 adjoining the front of the card. The first raised edge 518 at the square corner 522 may have a first cross-sectional profile perpendicular to the longitudinal axis of the card that corresponds to the cross-sectional profile of a first spline. The first cross-sectional profile may taper from the first square corner 522 to the first curved segment 514. Additionally, the card 506 may include a second raised edge 524. The second raised edge 524 may be parallel to the first raised edge 518. The second raised edge 524 may be straight and may extend from a second square corner 526 to a second curved segment 516 of a second rounded corner 509 adjoining the front of the card. The second raised edge 524 at the second square corner 526 may have a second cross-sectional profile perpendicular to the longitudinal axis of the card that corresponds to the cross-sectional profile of a second spline. The second cross-sectional profile may taper from the second square corner 526 to the second rounded corner 509.

Referring to FIG. 91, the thickness (or gauge) of the card may reflect the width of the opening to a concavity as well as the thickness of the flexible material to be anchored in the concavity. For instance, the gauge of the card may be less than the width of the opening minus two times the thickness of the flexible material to be anchored therein. Similarly, the size and shape of the spline may reflect these and other parameters.

Referring to FIG. 92, the first cross-sectional profile 528 may simulate a first square spline cross- sectional profile, and the second cross-sectional profile 530 may simulate a second square spline cross-sectional profile. For instance, the first square spline may measure about 0.15 inches on a side and the second square spline may measure about 0.1 or 0.12 inches on a side.

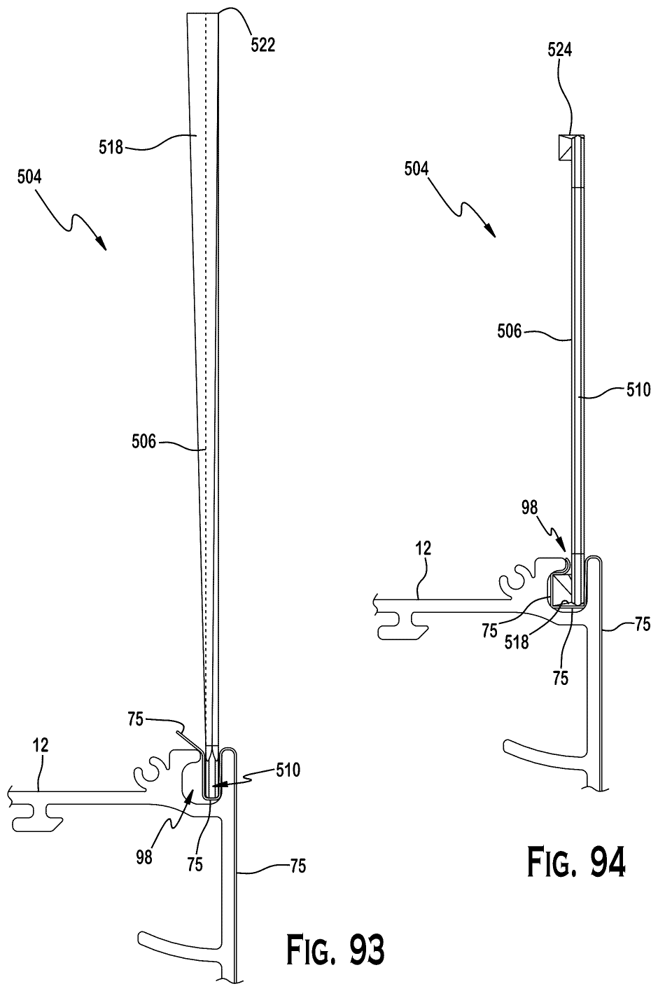

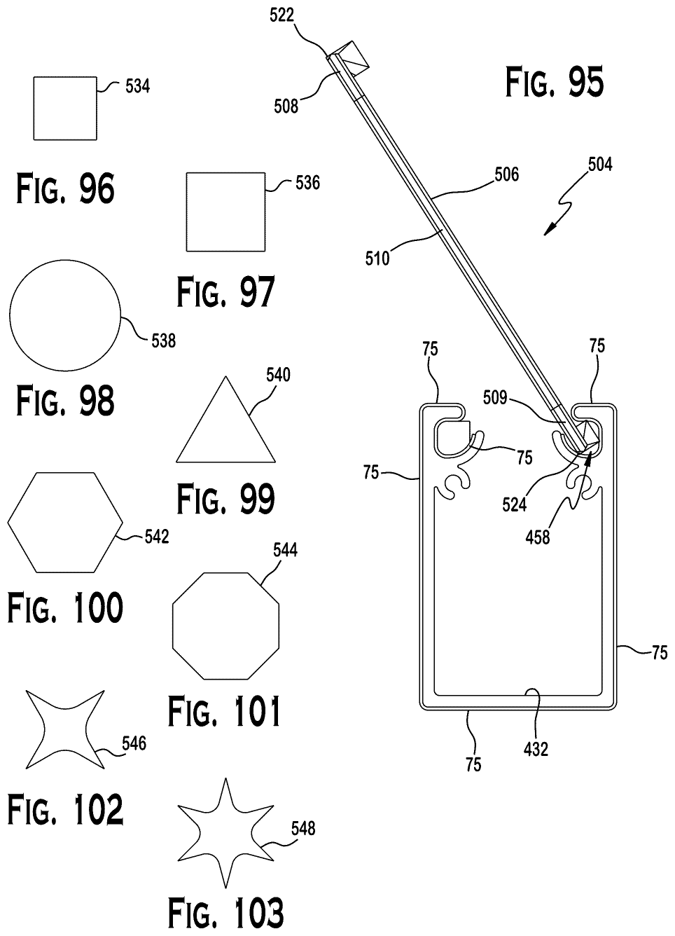

Referring to FIG. 93 the front rounded edge (or tip) 510 of the hand tool 504 may be used to push or tamp a flexible material 75 into the superior cavity 98 of a work piece (e.g., a cassette or cover track). By contrast, FIG. 94 shows the hand tool 504 traversing the superior cavity 98 of the workpiece and expanding the flexible material 75 in the superior cavity 98 with the first raised edge 518. Generally, a rigid spline 532 may be threaded or pushed into place within the expanded pocket of flexible material. Preferably, a rigid spline may be formed from a hardened nylon polymer (e.g., trimmer line). Similarly, FIG. 95 shows the hand tool 504 traversing the front rounded cavity 458 of a bottom bar cover track and expanding the fabric material 75 with the second raised edge 524. The second raised edge 524 may correspond to the cross-section of a second rigid spline, the second rigid spile having smaller cross-sectional dimensions than the first rigid spline. See e.g., FIGS. 96 and 97.

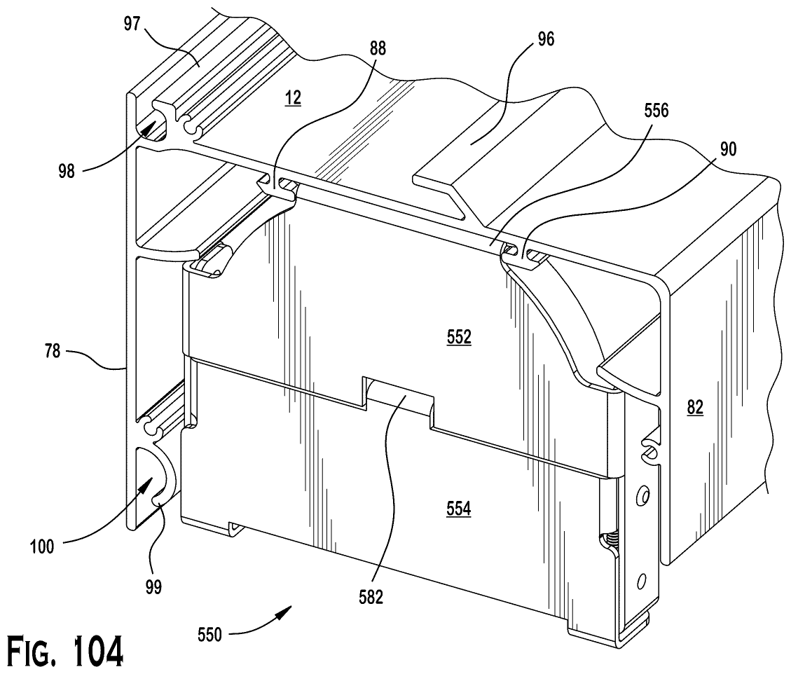

Referring to FIGS. 96-103, splines-elastomeric 502 or rigid 532-may have various shapes. For instance, although the splines in FIGS. 84-87 possess a square cross-section, a spline may possess any suitable cross-section provided the spline may be used to securely anchor a fold of a particular flexible material in a particular concavity. For example, without limitation, a spline may have a first square cross-section 534 (see e.g., FIG. 96), a second square cross-section 536 (see e.g., FIG. 97), a circular cross-section 538 (see e.g., FIG. 98), a triangular cross-section 540 (see e.g., FIG. 99), a hexagonal cross-section 542 (see e.g., FIG. 100), an octagonal cross-section 544 (see e.g., FIG. 101), a 4-point star cross-section 546 (see e.g. FIG. 102), or a 6-point star cross-section 548 (see e.g., FIG. 103).

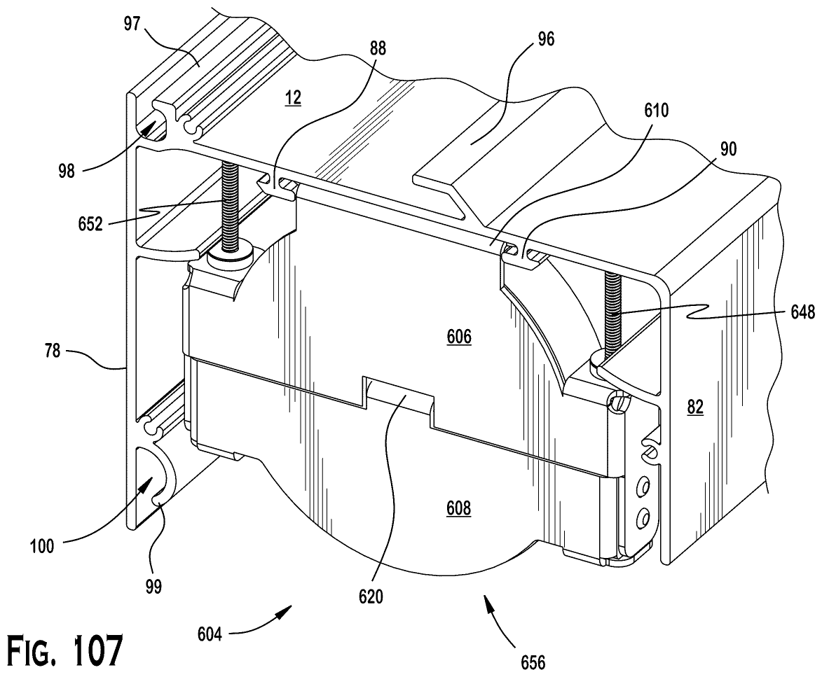

FIG. 104 shows a cassette 12 and a second embodiment of a tube bracket 550, the tube bracket being mounted to the port side of the cassette 12. Referring to FIG. 105 and FIG. 106, the tube bracket 550 may include an upper plate 552 and a lower plate 554.

The upper plate 552 may include a first superior tab 556. The first superior tab 556 may be disposed perpendicular to the upper plate 552. The first superior tab 552 may be configured and dimensioned to be received between the proximal rail 88 and the distal rail 90 of a cassette 12. Additionally, the upper plate 552 may include a port side wing 558 disposed perpendicular to the upper plate 552. The port side wing 558 may further include a first inferior tab 560. The first inferior tab 560 being disposed perpendicular to the upper plate 552 and the port side wing 558. The first inferior tab 560 may include a first through hole 562, and the first through hole 562 may include a first side wall. The first side wall may include a first screw thread. Additionally, the port side wing 558 may include a first guide plate 564. The first guide plate 564 being disposed on the starboard side of the port side wing 558. The first guide plate 564 may include a first elongated slot 566. The first elongated slot 566 may have a first longitudinal axis. The first guide plate 564 may be arranged on the port side wing 558 such that the first longitudinal is perpendicular to the first inferior tab 560. A first pin 568 may extend through the port side wing 558 and the first elongated slot 566. Similarly, the upper plate 552 may include a starboard side wing 570 disposed perpendicular to the upper plate 552. The starboard side wing 570 may further include a second inferior tab 572. The second inferior tab 572 being disposed perpendicular to the upper plate 552 and the starboard side wing 570. The second inferior tab 572 may include a second through hole 574, and the second through hole 574 may include a second side wall. The second side wall may include a second screw thread. Additionally, the starboard side wing 570 may include a second guide plate 576. The second guide plate 576 and the first guide plate 564 may be substantially the same in form. The second guide plate 576 may be disposed on the port side of the starboard side wing 570. The second guide plate 576 may include a second elongated slot 578. The second elongated slot 578 may have a second longitudinal axis. The second guide plate 576 may be arranged on the starboard side wing 570 opposite the first guide plate 564 and such that the second longitudinal axis is perpendicular to the second inferior tab 572. A second pin 580 may extend through the starboard side wing 570 and the second longitudinal slot 578.

The lower plate 554 may include a second superior tab 582. The second superior tab 582 may be disposed perpendicular to the lower plate 554. The second superior tab 582 may be configured and dimensioned to be slidably received in the mounting receptacle 359, 430 on the adjustable stop gear drive (ASGD) enclosure 202 and the clutch housing (or a tube motor housing) 390, respectively. The lower plate 554 further may include a third inferior tab 584 and a fourth inferior tab 586 spaced form the third inferior tab along an inferior edge 588 of the lower plate. The third inferior tab 584 may be disposed perpendicular to the lower plate 554. Also, the fourth inferior tab 586 may be disposed perpendicular to the lower plate 554. The third inferior tab 586 may include a third through hole 590, and the third through hole 590 may include a third side wall. The third side wall may include a third screw thread. Likewise, the fourth inferior tab 586 may include a fourth through hole 592, and the fourth through hole 592 may include a fourth side wall. The fourth side wall may include a fourth screw thread. A port side screw 594 may be arranged through the third through hole 590, the first through hole 562, and a first nut 598 on top of the first inferior tab 560. Also, a starboard side screw 596 may be arranged through the fourth through hole 592, the second through hole 574, and a second nut 560 on top of the second inferior tab 572.

Referring to FIG. 105, the tube bracket 550 may have a retracted configuration 600 in which the first inferior tab 560 and the third inferior tab 584 abut and the second inferior tab 572 and the fourth inferior tab 586 abut. In the retracted configuration 600, the first superior tab 552 and the second superior tab 582 may be separated by a first distance. Referring to FIG. 106, the tube bracket 550 may have an expanded configuration 602 in which the first inferior tab 560 and the third inferior tab 584 are spaced from each other and the second inferior tab 572 and the fourth inferior tab 586 are spaced from each other. In the expanded configuration 602, the first superior tab 552 and the second superior tab 582 may be separated by a second distance, the second distance being greater than the first distance.

In use, the distance between the first superior tab 552 and the second superior tab 582 may be changed incrementally by rotating the port side screw 594 and the starboard side screw 596. In one embodiment, rotating the port side screw 594 and the starboard side screw 596 in a clockwise direction may increase the distance between the first superior tab 552 and the second superior tab 582; whereas rotating the port side screw 594 and the starboard side screw 596 in a counter-clockwise direction may decrease the distance between the first superior tab 552 and the second superior tab 582. Hence, the tube bracket 550 may be used to adjust the vertical position of one side of the major tube 36 within the cassette 12 of a window shade apparatus 10. Adjustment of the vertical position of one or both sides of the major tube assembly within the cassette in this manner may allow the rotational axis of the major tube assembly to be precisely leveled.

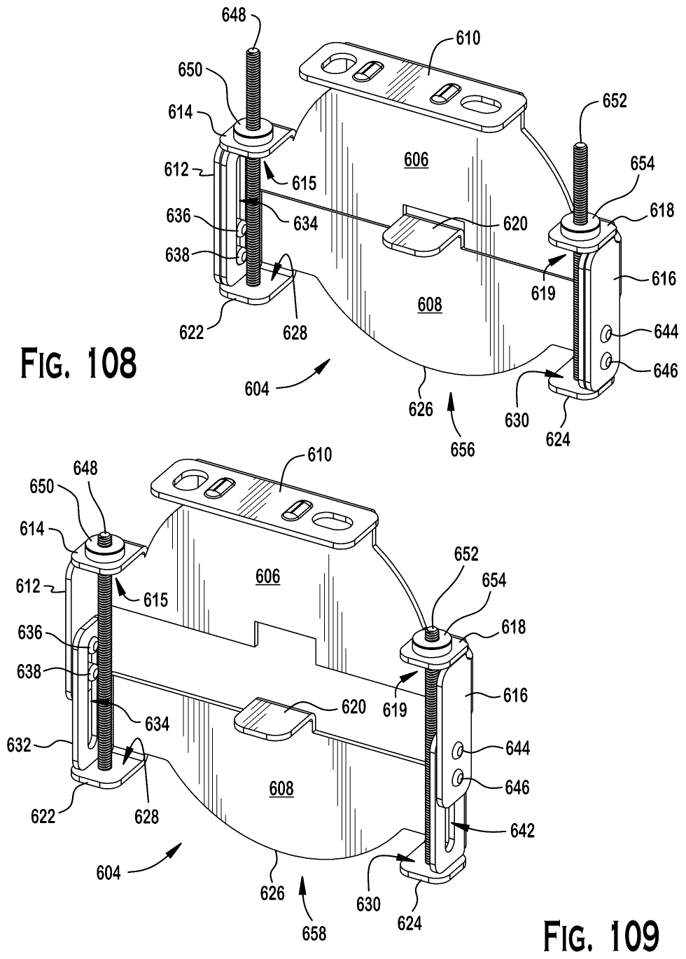

FIG. 107 shows a cassette 12 and a third embodiment of a tube bracket 604, the tube bracket being mounted to the port side of the cassette. Referring to FIG. 108 and FIG. 109, the tube bracket 604 may include an upper plate 606 and a lower plate 608.

The upper plate may include a third superior tab 610. The third superior tab 610 may be disposed perpendicular to the upper plate 606. The third superior tab 610 may be configured and dimensioned to be received between the proximal rail 88 and the distal rail 90 of a cassette 12. Additionally, the upper plate 606 further may include a port side wing 612 disposed perpendicular to the upper plate 606. The port side wing may include a first intermediate tab 614. The first intermediate tab 614 being disposed perpendicular to the upper plate 606 and the port side wing 612. The first intermediate tab 614 may include a seventh through hole 615, and the seventh through hole 615 may include a seventh side wall. The seventh side wall may include a seventh screw thread. Moreover, the first intermediate tab 618 may be located above the port side wing 616.-The upper plate 606 further may include a starboard side wing 616 disposed perpendicular to the upper plate 606. The starboard side wing may include a second intermediate tab 618. The second intermediate tab 618 may be disposed perpendicular to the upper plate 606 and the starboard side wing 616. The second intermediate tab 618 may include an eighth through hole 619, and the eighth through hole 619 may include a eighth side wall. The eighth side wall may include an eighth screw thread. Moreover, the second intermediate tab 618 may be located above the starboard side wing 616.

The lower plate 608 may include a fourth superior tab 620. The fourth superior tab may be disposed perpendicular to the lower plate 608. The fourth superior tab may be configured and dimensioned to be slidably received in the mounting receptacle 359, 430 on the adjustable stop gear drive (ASGD) enclosure 202 and the clutch housing (or a tube motor housing) 390, respectively. The lower plate 608 further may include a fifth inferior tab 622 and a sixth inferior tab 624 spaced from the fifth inferior tab along a second inferior edge 626 of the lower plate. The fifth inferior tab 622 may be disposed perpendicular to the lower plate 608. Also, the sixth inferior tab 624 may be disposed perpendicular to the lower plate 608. The fifth inferior tab 622 may include a fifth through hole 628, and the sixth inferior tab 624 may include a sixth through hole 630. The fifth through hole 628 may include a fifth side wall. The fifth side wall may include a fifth screw thread. Likewise, the sixth through hole 630 may include a sixth side wall, and the sixth side wall may include a sixth screw thread.

Moreover, the lower plate 608 may include a second port side wing 632. The second port side wing 632 may be disposed above and perpendicular to the fifth inferior tab 622. The second port side wing 632 may include a third elongated slot 634. The third elongated slot 634 may have a third longitudinal axis. The second port side wing 632 may be arranged above the fifth inferior tab 622 such that the third longitudinal axis is perpendicular to the fifth inferior tab 622. A first pin 636 and a second pin 638 may extend through the port side wing 612 of the upper plate 606 and the third elongated slot 634 in the second port side wing 632. Additionally, the lower plate 608 may include a second starboard side wing 640. The second starboard side wing 640 may be disposed above and perpendicular to the sixth inferior tab 624. The second starboard side wing 640 may include a fourth elongated slot 642. The fourth elongated slot 642 may have a fourth longitudinal axis. The second starboard side wing 632 may be arranged above the sixth inferior tab 624 such that the fourth longitudinal axis is perpendicular to the sixth inferior tab 624. A first pin 644 and a second pin 646 may extend through the starboard side wing 616 of the upper plate 606 and the fourth elongated slot 642 in the second port side wing 632.

A port side screw 648 may be arranged through the fifth through hole 628, the seventh through hole 615, and a first nut 650 on top of the first intermediate tab 614. Also, a starboard side screw 652 may be arranged through the sixth through hole 630, the eighth through hole 619, and a second nut 654 on top of the second intermediate tab 618.

Referring to FIG. 108, the tube bracket 604 may have a retracted configuration 656 in which the first intermediate tab 614 and the port side wing 612 of the upper plate abut and the second intermediate tab 618 and the starboard side wing 616 of the upper plate abut. In the retracted configuration 656, the third superior tab 610 and the fourth superior tab 620 may be separated by a first distance. Referring to FIG. 109, the tube bracket 604 may have an expanded configuration 658 in which the first intermediate tab 614 is spaced from the port side wing 612 of the upper plate and the second intermediate tab 618 is spaced from the starboard side wing 616 of the upper plate. In the expanded configuration, the third superior tab 610 and the fourth superior tab 620 may be separated by a second distance, the second distance being greater than the first distance.

In use, the distance between the first superior tab 610 and the second superior tab 620 may be changed by rotating the port side screw 648 and the starboard side screw 652. In one embodiment, rotating the port side screw 648 and the starboard side screw 652 in a clockwise direction may increase the distance between the third superior tab 610 and the fourth superior tab 620; whereas rotating the port side screw 648 and the starboard side screw 652 in a counter-clockwise direction may decrease the distance between the third superior tab and the fourth superior tab. Hence, the tube bracket 604 may be used to adjust the vertical position of one side of the major tube 36 within the cassette 12 of a window shade apparatus 10. Adjustment of the vertical position of one or both sides of the major tube 36 within the cassette 12 in this manner may allow the rotational axis of the major tube 36 to be precisely leveled.

While it has been illustrated and described what at present are considered to be preferred embodiments, it will be understood by those skilled in the art that various changes and modifications may be made, and equivalents may be substituted for elements thereof without departing from the true scope of the present invention, as defined in the appended claims. For instance, different worm gear configurations may be used to implement the DA device or the IAS device. Moreover, features and or elements from any disclosed embodiment may be used singly or in combination with other embodiments. Therefore, it is intended that the present invention not be limited to the described embodiments, but that it have the full scope defined by the language of the following claims, and equivalents thereof.

What is claimed is:

1. A window shade apparatus comprising:
a cassette for housing a window shade;
a major tube for spooling a sheet of flexible material;
a minor tube disposed adjacent to the major tube;
a bottom bar which comprises
a cover track,
a tubular rod having a central axis and which comprises
an opening aligned with the central axis, and
a bearing insert arranged in the opening, the bearing insert including
an annular flange, and
a hollow plug abutting the annular flange.
an end cap connected to the cover track, the end cap comprising
an end wall, and
a circular cylindrical shaft projecting from the end wall, the circular cylindrical shaft being telescopically received in the hollow plug;
a sheet of flexible material comprising
a first edge secured to the major tube,
a second edge secured to the minor tube, the sheet of flexible material traversing around the tubular rod such that the tubular rod divides the sheet of flexible material into a proximal sheet of flexible material extending between the major tube and the tubular rod and a distal sheet flexible material extending between the minor tube and the tubular rod; and
a differential adjustment device connected to the minor tube for selectively rotating the minor tube, the differential device comprising
a first worm drive for rotating the minor tube, and
a first shaft for operating the first worm drive.

2. The window shade apparatus of claim 1, further comprising:
an idler-adjustable stop device which comprises
a second worm drive for regulating the maximum deployment length of the sheet of flexible material that can be unspooled from the major tube, and
a second shaft for operating the second worm drive.
